(19) United States
(12) Patent Application Publication
(10) Pub. No.: US 2026/0030164 A1
(43) Pub. Date: Jan. 29, 2026

(54) LINK AGGREGATION MANAGEMENT

(71) Applicant: Intel Corporation, Santa Clara, CA (US)

(72) Inventors: Mohannad Fahim Ali, San Jose, CA (US); Swadesh Choudhary, Mountain View, CA (US); Debendra Das Sharma, Saratoga, CA (US); Mahesh S. Natu, Folsom, CA (US); Michelle C. Jen, Los Altos, CA (US)

(73) Assignee: Intel Corporation, Santa Clara, CA (US)

(21) Appl. No.: 19/341,954

(22) Filed: Sep. 26, 2025

Related U.S. Application Data
(60) Provisional application No. 63/809,540, filed on May 21, 2025.

(51) Int. Cl. G06F 12/0831; G06F 13/42

(52) U.S. Cl. CPC G06F 12/0831; G06F 13/4282; G06F 2213/0026

(57) ABSTRACT

A device, such as an I/O device, includes one or more ports to couple to one or more other devices, such as host devices, over two or more links, where the one or more ports include protocol circuitry to: implement a plurality of different link protocols, implement an aggregated link of the two or more links to couple to a given one of the one or more other devices, and manage a protocol resource based on the aggregated link.

### RELATED APPLICATIONS

This application claims benefit to U.S. Provisional Patent Application Ser. No. 63/809,540, filed May 21, 2025, which is incorporated by reference herein in its entirety.

### BACKGROUND

A datacenter may include one or more platforms each comprising at least one processor and associated memory modules. Each platform of the datacenter may facilitate the performance of any suitable number of processes associated with various applications running on the platform. These processes may be performed by the processors and other associated logic of the platforms. Each platform may additionally include I/O controllers, such as network adapter devices, which may be used to send and receive data on a network for use by the various applications.

### BRIEF DESCRIPTION OF THE DRAWINGS

FIG. 1 illustrates a block diagram of components of a datacenter in accordance with certain embodiments.

FIG. 2A illustrates a simplified block diagram of an example computing system utilizing a link compliant with a Compute Express Link (CXL)-based protocol.

FIG. 2B illustrates a simplified block diagram of example protocol circuitry.

FIGS. 3A-3C are simplified block diagrams illustrating example device types within a Compute Express Link (CXL) infrastructure.

FIG. 4 is a simplified block diagram illustrating memory pooling using a CXL protocol.

FIG. 5 is a simplified block diagram illustrating an example data center cluster architecture.

FIG. 6 is a simplified block diagram illustrating data transfers within an example data center cluster architecture.

FIG. 7 is a simplified block diagram illustrating an example link aggregation.

FIGS. 8A-8G are simplified block diagrams illustrating example topologies utilizing link aggregation.

FIG. 9A is a simplified block diagram illustrating an example device with a shared address translation cache for multiple links in a link aggregation.

FIG. 9B is a simplified block diagram illustrating an example device with separate link address translation caches for multiple links in a link aggregation.

FIG. 10 is a simplified flow diagram illustrating an example device with separate memory caches for multiple links in a link aggregation.

FIG. 11 is a simplified flow diagram illustrating an example device with a common memory cache for multiple links in a link aggregation.

FIG. 12 is a simplified block diagram illustrating an example I/O device coupled to multiple host devices.

FIG. 13 is a simplified flow diagram illustrating an example link aggregation coupling an I/O device to multiple host devices.

FIG. 14 is a simplified flow diagram illustrating an example host device with address decode circuitry in an example link aggregation.

FIG. 15 illustrates a block diagram of an example processor device in accordance with certain embodiments.

Like reference numbers and designations in the various drawings indicate like elements.

### DETAILED DESCRIPTION

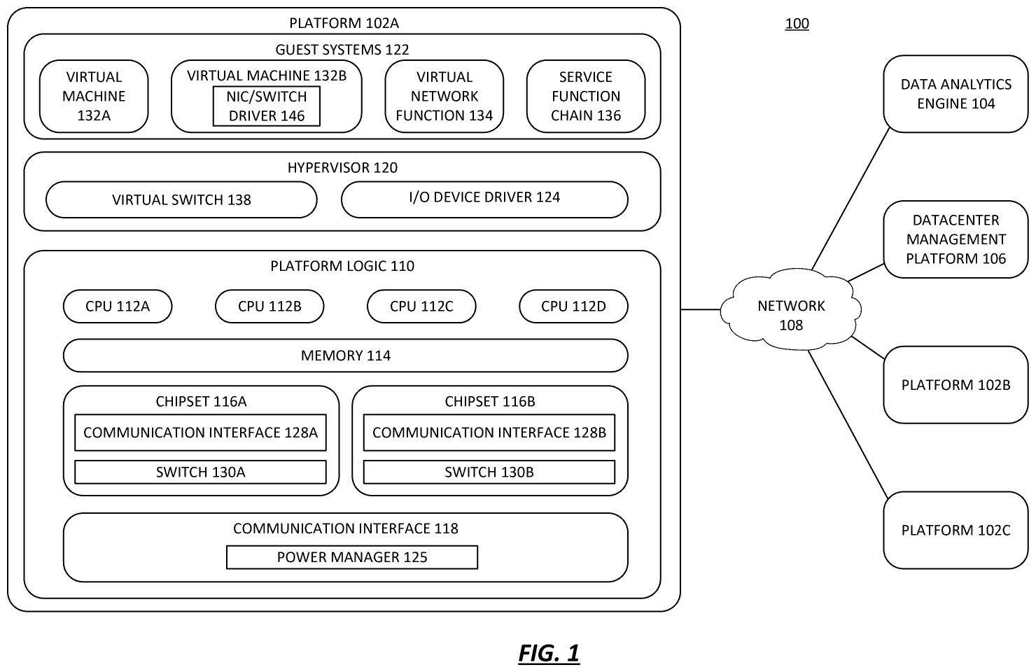

FIG. 1 illustrates a block diagram of components of a datacenter 100 in accordance with certain embodiments. In the embodiment depicted, datacenter 100 includes a plurality of platforms 102, data analytics engine 104, and datacenter management platform 106 coupled together through network 108. A platform 102 may include platform logic 110 with one or more central processing units (CPUs) 112, memories 114 (which may include any number of different modules), chipsets 116, communication interfaces 118, and any other suitable hardware and/or software to execute a hypervisor 120 or other operating system capable of executing processes associated with applications running on platform 102. In some embodiments, a platform 102 may function as a host platform for one or more guest systems 122 that invoke these applications. The platform may be logically or physically subdivided into clusters, and these clusters may be enhanced through specialized networking accelerators and the use of Compute Express Link (CXL) memory semantics to make such cluster more efficient, among other example enhancements.

Each platform 102 may include platform logic 110. Platform logic 110 comprises, among other logic enabling the functionality of platform 102, one or more CPUs 112, memory 114, one or more chipsets 116, and communication interface 118. Although three platforms are illustrated, datacenter 100 may include any suitable number of platforms. In various embodiments, a platform 102 may reside on a circuit board that is installed in a chassis, rack, compossible servers, disaggregated servers, or other suitable structures that comprises multiple platforms coupled together through network 108 (which may comprise, e.g., a rack or backplane switch).

CPUs 112 may each comprise any suitable number of processor cores. The cores may be coupled to each other, to memory 114, to at least one chipset 116, and/or to communication interface 118, through one or more controllers residing on CPU 112 and/or chipset 116. In particular embodiments, a CPU 112 is embodied within a socket that is permanently or removably coupled to platform 102. Although four CPUs are shown, a platform 102 may include any suitable number of CPUs.

Memory 114 may comprise any form of volatile or non-volatile memory including, without limitation, magnetic media (e.g., one or more tape drives), optical media, random access memory (RAM), read-only memory (ROM), flash memory, removable media, or any other suitable local or remote memory component or components. Memory 114 may be used for short, medium, and/or long-term storage by platform 102. Memory 114 may store any suitable data or information utilized by platform logic 110, including software embedded in a computer readable medium, and/or encoded logic incorporated in hardware or otherwise stored (e.g., firmware). Memory 114 may store data that is used by cores of CPUs 112. In some embodiments, memory 114 may also comprise storage for instructions that may be executed by the cores of CPUs 112 or other processing elements (e.g., logic resident on chipsets 116) to provide functionality associated with components of platform logic 110. Additionally or alternatively, chipsets 116 may each comprise memory that may have any of the characteristics described herein with respect to memory 114. Memory 114 may also store the results and/or intermediate results of the various calculations and determinations performed by CPUs 112 or processing elements on chipsets 116. In various embodiments, memory 114 may comprise one or more modules of system memory coupled to the CPUs through memory controllers (which may be external to or integrated with CPUs 112). In various embodiments, one or more particular modules of memory 114 may be dedicated to a particular CPU 112 or other processing device or may be shared across multiple CPUs 112 or other processing devices.

A platform 102 may also include one or more chipsets 116 comprising any suitable logic to support the operation of the CPUs 112. In various embodiments, chipset 116 may reside on the same package as a CPU 112 or on one or more different packages. Each chipset may support any suitable number of CPUs 112. A chipset 116 may also include one or more controllers to couple other components of platform logic 110 (e.g., communication interface 118 or memory 114) to one or more CPUs. Additionally or alternatively, the CPUs 112 may include integrated controllers. For example, communication interface 118 could be coupled directly to CPUs 112 via integrated I/O controllers resident on each CPU.

Chipsets 116 may each include one or more communication interfaces 128. Communication interface 128 may be used for the communication of signaling and/or data between chipset 116 and one or more I/O devices, one or more networks 108, and/or one or more devices coupled to network 108 (e.g., datacenter management platform 106 or data analytics engine 104). For example, communication interface 128 may be used to send and receive network traffic such as data packets. In a particular embodiment, communication interface 128 may be implemented through one or more I/O controllers, such as one or more physical network interface controllers (NICs), also known as network interface cards or network adapters. An I/O controller may include electronic circuitry to communicate using any suitable physical layer and data link layer standard such as Ethernet (e.g., as defined by an IEEE 802.3 standard), Fibre Channel, InfiniBand, Wi-Fi, or other suitable standard. An I/O controller may include one or more physical ports that may couple to a cable (e.g., an Ethernet cable). An I/O controller may enable communication between any suitable element of chipset 116 (e.g., switch 130) and another device coupled to network 108. In some embodiments, network 108 may comprise a switch with bridging and/or routing functions that is external to the platform 102 and operable to couple various I/O controllers (e.g., NICs) distributed throughout the datacenter 100 (e.g., on different platforms) to each other. In various embodiments an I/O controller may be integrated with the chipset (e.g., may be on the same integrated circuit or circuit board as the rest of the chipset logic) or may be on a different integrated circuit or circuit board that is electromechanically coupled to the chipset. In some embodiments, communication interface 128 may also allow I/O devices integrated with or external to the platform (e.g., disk drives, other NICs, etc.) to communicate with the CPU cores.

Switch 130 may couple to various ports (e.g., provided by NICs) of communication interface 128 and may switch data between these ports and various components of chipset 116 according to one or more link or interconnect protocols, such as Peripheral Component Interconnect Express (PCIe), Compute Express Link (CXL), HyperTransport, GenZ, OpenCAPI, and others, which may each alternatively or collectively apply the general principles and/or specific features discussed herein. Switch 130 may be a physical or virtual (e.g., software) switch.

Platform logic 110 may include an additional communication interface 118. Similar to communication interface 128, communication interface 118 may be used for the communication of signaling and/or data between platform logic 110 and one or more networks 108 and one or more devices coupled to the network 108. For example, communication interface 118 may be used to send and receive network traffic such as data packets. In a particular embodiment, communication interface 118 comprises one or more physical I/O controllers (e.g., NICs). These NICs may enable communication between any suitable element of platform logic 110 (e.g., CPUs 112) and another device coupled to network 108 (e.g., elements of other platforms or remote nodes coupled to network 108 through one or more networks). In particular embodiments, communication interface 118 may allow devices external to the platform (e.g., disk drives, other NICs, etc.) to communicate with the CPU cores. In various embodiments, NICs of communication interface 118 may be coupled to the CPUs through I/O controllers (which may be external to or integrated with CPUs 112). Further, as discussed herein, I/O controllers may include a power manager 125 to implement power consumption management functionality at the I/O controller (e.g., by automatically implementing power savings at one or more interfaces of the communication interface 118 (e.g., a PCIe interface coupling a NIC to another element of the system), among other example features.

Platform logic 110 may receive and perform any suitable types of processing requests. A processing request may include any request to utilize one or more resources of platform logic 110, such as one or more cores or associated logic. For example, a processing request may comprise a processor core interrupt; a request to instantiate a software component, such as an I/O device driver 124 or virtual machine 132; a request to process a network packet received from a virtual machine 132 or device external to platform 102 (such as a network node coupled to network 108); a request to execute a workload (e.g., process or thread) associated with a virtual machine 132, application running on platform 102, hypervisor 120 or other operating system running on platform 102; or other suitable request.

In various embodiments, processing requests may be associated with guest systems 122. A guest system may comprise a single virtual machine (e.g., virtual machine 132a or 132b) or multiple virtual machines operating together (e.g., a virtual network function (VNF) 134 or a service function chain (SFC) 136). As depicted, various embodiments may include a variety of types of guest systems 122 present on the same platform 102.

A virtual machine 132 may emulate a computer system with its own dedicated hardware. A virtual machine 132 may run a guest operating system on top of the hypervisor 120. The components of platform logic 110 (e.g., CPUs 112, memory 114, chipset 116, and communication interface 118) may be virtualized such that it appears to the guest operating system that the virtual machine 132 has its own dedicated components.

A virtual machine 132 may include a virtualized NIC (vNIC), which is used by the virtual machine as its network interface. A vNIC may be assigned a media access control (MAC) address, thus allowing multiple virtual machines 132 to be individually addressable in a network.

In some embodiments, a virtual machine 132b may be paravirtualized. For example, the virtual machine 132b may include augmented drivers (e.g., drivers that provide higher performance or have higher bandwidth interfaces to underlying resources or capabilities provided by the hypervisor 120). For example, an augmented driver may have a faster interface to underlying virtual switch 138 for higher network performance as compared to default drivers.

VNF 134 may comprise a software implementation of a functional building block with defined interfaces and behavior that can be deployed in a virtualized infrastructure. In particular embodiments, a VNF 134 may include one or more virtual machines 132 that collectively provide specific functionalities (e.g., wide area network (WAN) optimization, virtual private network (VPN) termination, firewall operations, load-balancing operations, security functions, etc.). A VNF 134 running on platform logic 110 may provide the same functionality as traditional network components implemented through dedicated hardware. For example, a VNF 134 may include components to perform any suitable NFV workloads, such as virtualized Evolved Packet Core (vEPC) components, Mobility Management Entities, 3rd Generation Partnership Project (3GPP) control and data plane components, etc.

SFC 136 is group of VNFs 134 organized as a chain to perform a series of operations, such as network packet processing operations. Service function chaining may provide the ability to define an ordered list of network services (e.g., firewalls, load balancers) that are stitched together in the network to create a service chain.

A hypervisor 120 (also known as a virtual machine monitor) may comprise logic to create and run guest systems 122. The hypervisor 120 may present guest operating systems run by virtual machines with a virtual operating platform (e.g., it appears to the virtual machines that they are running on separate physical nodes when they are actually consolidated onto a single hardware platform) and manage the execution of the guest operating systems by platform logic 110. Services of hypervisor 120 may be provided by virtualizing in software or through hardware assisted resources that require minimal software intervention, or both. Multiple instances of a variety of guest operating systems may be managed by the hypervisor 120. Each platform 102 may have a separate instantiation of a hypervisor 120.

Hypervisor 120 may be a native or bare-metal hypervisor that runs directly on platform logic 110 to control the platform logic and manage the guest operating systems. Alternatively, hypervisor 120 may be a hosted hypervisor that runs on a host operating system and abstracts the guest operating systems from the host operating system. Various embodiments may include one or more non-virtualized platforms 102, in which case any suitable characteristics or functions of hypervisor 120 described herein may apply to an operating system of the non-virtualized platform.

Hypervisor 120 may include a virtual switch 138 that may provide virtual switching and/or routing functions to virtual machines of guest systems 122. The virtual switch 138 may comprise a logical switching fabric that couples the vNICs of the virtual machines 132 to each other, thus creating a virtual network through which virtual machines may communicate with each other. Virtual switch 138 may also be coupled to one or more networks (e.g., network 108) via physical NICs of communication interface 118 so as to allow communication between virtual machines 132 and one or more network nodes external to platform 102 (e.g., a virtual machine running on a different platform 102 or a node that is coupled to platform 102 through the Internet or other network). Virtual switch 138 may comprise a software element that is executed using components of platform logic 110. In various embodiments, hypervisor 120 may be in communication with any suitable entity (e.g., a SDN controller) which may cause hypervisor 120 to reconfigure the parameters of virtual switch 138 in response to changing conditions in platform 102 (e.g., the addition or deletion of virtual machines 132 or identification of optimizations that may be made to enhance performance of the platform).

Hypervisor 120 may include any suitable number of I/O device drivers 124. I/O device driver 124 represents one or more software components that allow the hypervisor 120 to communicate with a physical I/O device. In various embodiments, the underlying physical I/O device may be coupled to any of CPUs 112 and may send data to CPUs 112 and receive data from CPUs 112. The underlying I/O device may utilize any suitable communication protocol, such as PCI, PCIe, Universal Serial Bus (USB), Serial Attached SCSI (SAS), Serial ATA (SATA), InfiniBand, Fibre Channel, an IEEE 802.3 protocol, an IEEE 802.11 protocol, or other current or future signaling protocol.

The underlying I/O device may include one or more ports operable to communicate with cores of the CPUs 112. In one example, the underlying I/O device is a physical NIC or physical switch. For example, in one embodiment, the underlying I/O device of I/O device driver 124 is a NIC of communication interface 118 having multiple ports (e.g., Ethernet ports).

In other embodiments, underlying I/O devices may include any suitable device capable of transferring data to and receiving data from CPUs 112, such as an audio/video (A/V) device controller (e.g., a graphics accelerator or audio controller); a data storage device controller, such as a flash memory device, magnetic storage disk, or optical storage disk controller; a wireless transceiver; a network processor; or a controller for another input device such as a monitor, printer, mouse, keyboard, or scanner; or other suitable device.

In various embodiments, when a processing request is received, the I/O device driver 124 or the underlying I/O device may send an interrupt (such as a message signaled interrupt) to any of the cores of the platform logic 110. For example, the I/O device driver 124 may send an interrupt to a core that is selected to perform an operation (e.g., on behalf of a virtual machine 132 or a process of an application). Before the interrupt is delivered to the core, incoming data (e.g., network packets) destined for the core might be cached at the underlying I/O device and/or an I/O block associated with the CPU 112 of the core. In some embodiments, the I/O device driver 124 may configure the underlying I/O device with instructions regarding where to send interrupts.

In some embodiments, as workloads are distributed among the cores, the hypervisor 120 may steer a greater number of workloads to the higher performing cores than the lower performing cores. In certain instances, cores that are exhibiting problems such as overheating or heavy loads may be given less tasks than other cores or avoided altogether (at least temporarily). Workloads associated with applications, services, containers, and/or virtual machines 132 can be balanced across cores using network load and traffic patterns rather than just CPU and memory utilization metrics.

The elements of platform logic 110 may be coupled together in any suitable manner. For example, a bus may couple any of the components together. A bus may include any known interconnect, such as a multi-drop bus, a mesh interconnect, a ring interconnect, a point-to-point interconnect, a serial interconnect, a parallel bus, a coherent (e.g., cache coherent) bus, a layered protocol architecture, a differential bus, or a Gunning transceiver logic (GTL) bus.

Elements of the data system 100 may be coupled together in any suitable, manner such as through one or more networks 108. A network 108 may be any suitable network or combination of one or more networks operating using one or more suitable networking protocols. A network may represent a series of nodes, points, and interconnected communication paths for receiving and transmitting packets of information that propagate through a communication system. For example, a network may include one or more firewalls, routers, switches, security appliances, antivirus servers, or other useful network devices. A network offers communicative interfaces between sources and/or hosts, and may comprise any local area network (LAN), wireless local area network (WLAN), metropolitan area network (MAN), Intranet, Extranet, Internet, wide area network (WAN), virtual private network (VPN), cellular network, or any other appropriate architecture or system that facilitates communications in a network environment. A network can comprise any number of hardware or software elements coupled to (and in communication with) each other through a communications medium. In various embodiments, guest systems 122 may communicate with nodes that are external to the datacenter 100 through network 108.

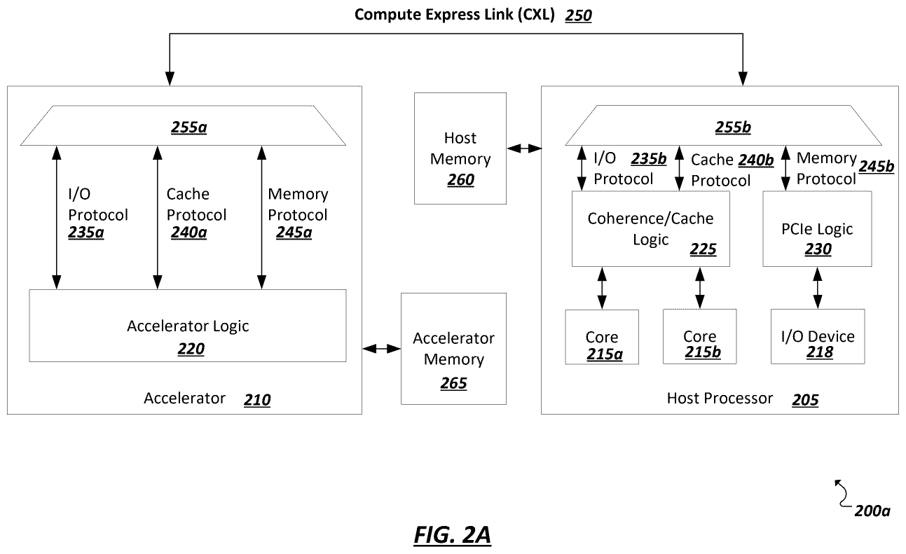

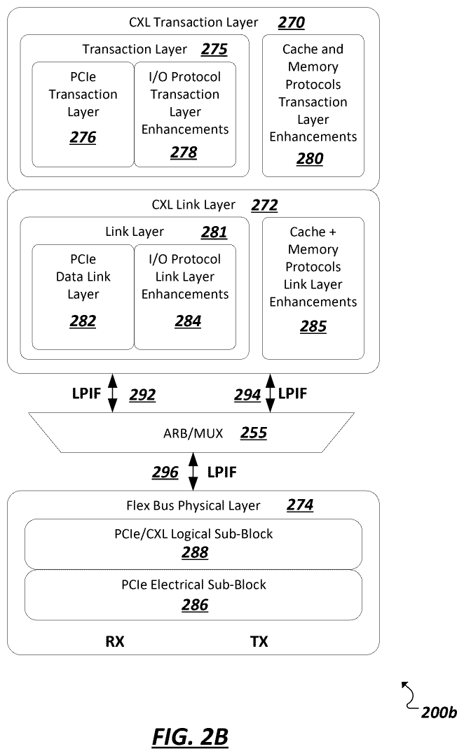

FIGS. 2A-2B are simplified block diagrams illustrating example protocol logic, implemented in hardware and/or software, to implement a Compute Express Link (CXL) protocol. It should be appreciated, that while much of the discussion centers on features provided by a CXL-protocol and communication channels compliant with CXL, that other substitute protocols with similar, comparable features may be substituted for CXL in the embodiments discussed below. The CXL interconnect protocol is designed to provide an improved, high-speed CPU-to-device and CPU-to-memory interconnect designed to accelerate next-generation data center performance, among other application. CXL maintains memory coherency between the CPU memory space and memory on attached devices, which allows resource sharing for higher performance, reduced software stack complexity, and lower overall system cost, among other example advantages. CXL enables communication between host processors (e.g., CPUs) and a set of workload accelerators (e.g., graphics processing units (GPUs), field programmable gate array (FPGA) devices, tensor and vector processor units, machine learning accelerators, networking accelerators, purpose-built accelerator solutions, among other examples). Indeed, CXL is designed to provide a standard interface for high-speed communications, as accelerators are increasingly used to complement CPUs in support of emerging computing applications such as artificial intelligence, machine learning and other applications.

A CXL link may be a low-latency, high-bandwidth discrete or on-package link that supports dynamic protocol multiplexing of coherency, memory access, and input/output (I/O) protocols. Among other applications, a CXL link may enable an accelerator to access system memory as a caching agent and/or host system memory, among other examples. CXL is a dynamic multi-protocol technology designed to support a vast spectrum of accelerators. CXL provides a rich set of sub-protocols that include I/O semantics similar to PCIe (CXL.io), caching protocol semantics (CXL.cache), and memory access semantics (CXL.mem) over a discrete or on-package link. Based on the particular accelerator usage model, all of the CXL protocols or only a subset of the protocols may be enabled. In some implementations, CXL may be built upon the well-established, widely adopted PCIe infrastructure (e.g., PCIe 5.0), leveraging the PCIe physical and electrical interface to provide advanced protocol in areas include I/O, memory protocol (e.g., allowing a host processor to share memory with an accelerator device), and coherency interface.

The protocols, or sub-protocols, of CXL—CXL.io, CXL.cache, and CXL.mem—may define specific protocol rule to serve different classes of applications. For instance, CXL.io is an I/O protocol based on the PCIe transaction model and may serve as the control and management layer of the CXL stack. Using PCIe semantics, CXL.io can be used to handle device discovery, enumeration, configuration space accesses, interrupts, and other standard I/O functions. Given that it builds on PCIe, CXL.io may be used to ensure that the CXL device remains backward-compatible with PCIe-based systems at the management level, allowing operating systems and firmware to treat the CXL device like a conventional PCIe device for setup and control (e.g., even given the higher-level CXL capabilities enabled at the device). CXL.mem is a cache coherent protocol adapted to allow a device (e.g., a host device) coupled to the CXL device to access the memory of the CXL device and perform direct load/store operations into the CXL device's attached memory (e.g., implemented as local DRAM, high-bandwidth memory (HBM), or persistent memory). CXL.mem transactions are coherent with the attached device's (e.g. host CPU) caches, meaning that if a processor core has cached a line from CXL device memory, CXL ensures consistency between the cached copy and the CXL device's underlying memory. This makes CXL.mem suitable for memory expansion (e.g., increasing system capacity with device-side DRAM) and memory pooling (e.g., allowing multiple hosts to dynamically allocate shared memory resources) without breaking coherency models expected by the CPU, among other example uses. CXL.cache is complimentary to CXL.mem, enabling the CXL device (e.g., an accelerator, GPU, smart NIC, etc.) to cache memory of its link partner (e.g., host memory of a host processor). CXL.cache can thus be used to perform coherent read and write operations directly to the host's memory hierarchy. This allows CXL devices to share data with the CPU or other host, for instance, without explicit software-managed copies and without risking incoherence between CXL device and host caches, among other example benefits. CXL.cache may be used, for instance, in systems with tightly coupled accelerator designs where the CXL device/accelerator uses and benefits from frequent, low-latency access to host-resident data, among other example uses.

Turning to FIG. 2A, a simplified block diagram 200a is shown illustrating an example system utilizing a CXL link 250. For instance, the link 250 may interconnect a host processor 205 (e.g., CPU) to an accelerator device 210. In this example, the host processor 205 includes one or more processor cores (e.g., 215a-b) and one or more I/O devices (e.g., 218). Host memory (e.g., 260) may be provided with the host processor (e.g., on the same package or die). The accelerator device 210 may include accelerator logic 220 and, in some implementations, may include its own memory (e.g., accelerator memory 265). In this example, the host processor 205 may include circuitry to implement coherence/cache logic 225 and interconnect logic (e.g., PCIe logic 230). CXL multiplexing logic (e.g., 255a-b) may also be provided to enable multiplexing of CXL protocols (e.g., I/O protocol 235a-b (e.g., CXL.io), caching protocol 240a-b (e.g., CXL.cache), and memory access protocol 245a-b (CXL.mem)), thereby enabling data of any one of the supported protocols (e.g., 235a-b, 240a-b, 245a-b) to be sent, in a multiplexed manner, over the link 250 between host processor 705 and accelerator device 210.

In some implementations, a Flex Bus™ port may be utilized in concert with CXL-compliant links to flexibly adapt a device to interconnect with a wide variety of other devices (e.g., other processor devices, accelerators, switches, memory devices (e.g., near memory, far memory, pooled memory, tiered memory, cache, etc.), among other examples). A Flex Bus port is a flexible high-speed port that is statically configured to support either a PCIe or CXL link (and potentially also links of other protocols and architectures). A Flex Bus port allows designs to choose between providing native PCIe protocol or CXL over a high-bandwidth, off-package link. Selection of the protocol applied at the port may happen during boot time via auto negotiation and be based on the device that is plugged into the slot. Flex Bus uses PCIe electricals, making it compatible with PCIe retimers, and adheres to standard PCIe form factors for an add-in card.

FIG. 2B is a simplified block diagram 200b illustrating an example protocol stack and associated logic (implemented in hardware and/or software) utilized to implement CXL links. For instance, the protocol logic may be organized as multiple layers to implement the multiple protocols supported by the port. For instance, a port may include transaction layer logic (e.g., 270), link layer logic (e.g., 272), and physical layer logic (e.g., 274) (e.g., implemented all or in-part in circuitry). For instance, a transaction (or protocol) layer (e.g., 270) may be subdivided into transaction layer logic 275 that implements a PCIe transaction layer 276 and CXL transaction layer enhancements 278 (for CXL.io) of a base PCIe transaction layer 276, and logic 280 to implement cache (e.g., CXL.cache) and memory (e.g., CXL.mem) protocols for a CXL link. Similarly, link layer logic 272 may be provided to implement a base PCIe data link layer 282 and a CXL link layer (for CXl.io) representing an enhanced version of the PCIe data link layer 284. A CXL link layer 272 may also include cache and memory link layer enhancement logic 285 (e.g., for CXL.cache and CXL.mem).

Continuing with the example of FIG. 2B, a CXL link layer logic 272 may interface with CXL arbitration/multiplexing (ARB/MUX) logic 255, which interleaves the traffic from the two logic streams (e.g., PCIe/CXL.io and CXL.cache/CXL.mem), among other example implementations. During link training, the transaction and link layers are configured to operate in either PCIe mode or CXL mode. In some instances, a host CPU may support implementation of either PCIe or CXL mode, while other devices, such as accelerators, may only support CXL mode, among other examples. In some implementations, the port (e.g., a Flex Bus port) may utilize a physical layer 274 based on a PCIe physical layer (e.g., PCIe electrical PHY 286). For instance, a Flex Bus physical layer may be implemented as a converged logical physical layer 288 that can operate in either PCIe mode or CXL mode based on results of alternate mode negotiation during the link training process. In some implementations, the physical layer may support multiple signaling rates (e.g., 8 GT/s, 16 GT/s, 32 GT/s, etc.) and multiple link widths (e.g., x16, x8, x4, x2, x1, etc.). In PCIe mode, links implemented by the port may be fully compliant with native PCIe features (e.g., as defined in the PCIe specification), while in CXL mode, the link supports all features defined for CXL. Accordingly, a Flex Bus port may provide a point-to-point interconnect that can transmit native PCIe protocol data or dynamic multi-protocol CXL data to provide I/O, coherency, and memory protocols, over PCIe electricals, among other examples.

The CXL I/O protocol, CXL.io, provides a non-coherent load/store interface for I/O devices. Transaction types, transaction packet formatting, credit-based flow control, virtual channel management, and transaction ordering rules in CXL.io may follow all or a portion of the PCIe definition. CXL cache coherency protocol, CXL.cache, defines the interactions between the device and host as a number of requests that each have at least one associated response message and sometimes a data transfer. The interface consists of three channels in each direction: Request, Response, and Data.

The CXL memory protocol, CXL.mem, is a transactional interface between the processor and memory and uses the physical and link layers of CXL when communicating across dies. CXL.mem can be used for multiple different memory attach options including when a memory controller is located in the host CPU, when the memory controller is within an accelerator device, or when the memory controller is moved to a memory buffer chip, among other examples. CXL.mem may be applied to transactions involving different memory types (e.g., volatile, persistent, etc.) and configurations (e.g., flat, hierarchical, etc.), among other example features. In some implementations, a coherency engine of the host processor may interface with memory using CXL.mem requests and responses. In this configuration, the CPU coherency engine is regarded as the CXL.mem Master and the Mem device is regarded as the CXL.mem Subordinate. The CXL.mem Master is the agent which is responsible for sourcing CXL.mem requests (e.g., reads, writes, etc.) and a CXL.mem Subordinate is the agent which is responsible for responding to CXL.mem requests (e.g., data, completions, etc.). When the Subordinate is an accelerator, CXL.mem protocol assumes the presence of a device coherency engine (DCOH). This agent is assumed to be responsible for implementing coherency related functions such as snooping of device caches based on CXL.mem commands and update of metadata fields. In implementations, where metadata is supported by device-attached memory, it can be used by the host to implement a coarse snoop filter for CPU sockets, among other example uses.

In some implementations, an interface may be provided to couple circuitry or other logic (e.g., an intellectual property (IP) block or other hardware element) implementing a link layer (e.g., 272) to circuitry or other logic (e.g., an IP block or other hardware element) implementing at least a portion of a physical layer (e.g., 274) of a protocol. For instance, an interface based on a Logical PHY Interface (LPIF) specification to define a common interface between a link layer controller, module, or other logic and a module implementing a logical physical layer (“logical PHY” or “logPHY”) to facilitate interoperability, design and validation re-use between one or more link layers and a physical layer for an interface to a physical interconnect, such as in the example of FIG. 2B. Additionally, as in the example of FIG. 2B, an interface may be implemented with logic (e.g., 281, 285) to simultaneously implement and support multiple protocols. Further, in such implementations, an arbitration and multiplexer layer (e.g., 255) may be provided between the link layer (e.g., 272) and the physical layer (e.g., 274). In some implementations, each block (e.g., 255, 274, 281, 285) in the multiple protocol implementation may interface with the other block via an independent interface (e.g., 292, 294, 296). In cases where bifurcation is supported, each bifurcated port may likewise have its own independent interface, among other examples.

CXL is a dynamic multi-protocol technology designed to support accelerators and memory devices. CXL provides a rich set of protocols. CXL.io is for discovery and enumeration, error reporting, peer-to-peer (P2P) accesses to CXL memory and host physical address (HPA) lookup. CXL.cache and CXL.mem protocols may be implemented by various accelerator or memory device usage models. An important benefit of CXL is that it provides a low-latency, high-bandwidth path for an accelerator to access the system and for the system to access the memory attached to the CXL device. The CXL 2.0 specification enabled additional usage models, including managed hot-plug, security enhancements, persistent memory support, memory error reporting, and telemetry. The CXL 2.0 specification also enables single-level switching support for fan-out as well as the ability to pool devices across multiple virtual hierarchies, including multi-domain support of memory devices. The CXL 2.0 specification also enables these resources (memory or accelerators) to be off-lined from one domain and on-lined into another domain, thereby allowing the resources to be time-multiplexed across different virtual hierarchies, depending on their resource demand. Additionally, the CXL 3.0 specification doubled the bandwidth while enabling still further usage models beyond those introduced in CXL 2.0. For instance, the CXL 3.0 specification provides for PAM-4 signaling, leveraging the PCIe Base Specification PHY along with its CRC and FEC, to double the bandwidth, with provision for an optional flit arrangement for low latency. Multi-level switching is enabled with the CXL 3.0 specification, supporting up to 4K Ports, to enable CXL to evolve as a fabric extending, including non-tree topologies, to the Rack and Pod level. The CXL 3.0 specification enables devices to perform direct peer-to-peer accesses to host-managed device memory (HDM) using Unordered I/O (UIO) (in addition to memory-mapped I/O (MMIO)) to deliver performance at scale. Snoop Filter support can be implemented in Type 2 and Type 3 devices to enable direct peer-to-peer accesses using the back-invalidate channels introduced in CXL.mem. Shared memory support across multiple virtual hierarchies is provided for collaborative processing across multiple virtual hierarchies, among other example features.

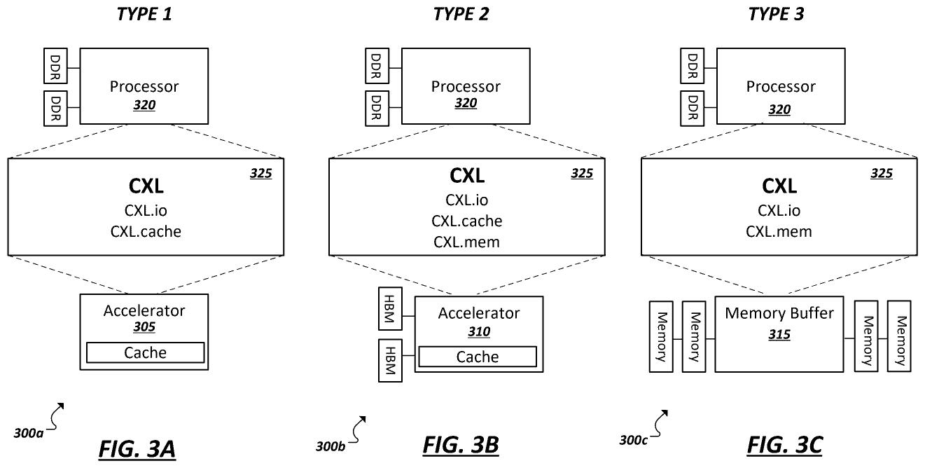

CXL is a high-performance I/O bus architecture that is used to interconnect peripheral devices that can be either traditional non-coherent I/O devices, memory devices, or accelerators with additional capabilities. When Type 2 and Type 3 device memory is exposed to the host, it is referred to as Host-managed Device Memory (HDM). The coherence management of this memory may be Host-only Coherent (HDM-H), Device Coherent (HDM-D), and Device Coherent using Back-Invalidation Snoop (HDM-DB). The host and device must have a common understanding of the type of HDM for each address region. FIGS. 3A-3C are simplified block diagrams 300a-c showing examples of CXL Type 1 devices (e.g., 305), Type 2 devices (e.g., 310), and Type 3 devices (e.g., 315). A CXL device (e.g., 305, 310, 315) may couple to a host processor (e.g., 320) via a CXL interconnect 325. Different CXL device types may utilize different combinations of the CXL protocols (or sub-protocols) (e.g., CXL.io, CXL.mem, CXL.cache).

In CXL, a “Type 1” devices have special needs for which having a fully coherent cache in the device becomes valuable. For such devices, standard producer-consumer ordering models do not work well. One example of a device with special requirements is to perform complex atomics that are not part of the standard suite of atomic operations present on PCIe. Basic cache coherency allows an accelerator to implement any ordering model it chooses and allows it to implement an unlimited number of atomic operations. These tend to require only a small capacity cache which can easily be tracked by standard processor snoop filter mechanisms. The size of cache that can be supported for such devices depends on the host's snoop filtering capacity. CXL supports such devices using its optional CXL.cache link over which an accelerator can use CXL.cache protocol for cache coherency transactions.

CXL “Type 2” devices, in addition to fully coherent cache, also have memory, for example DDR, High-Bandwidth Memory (HBM), or other memory attached to the device. These devices execute against memory, but their performance comes from having massive bandwidth between the accelerator and device-attached memory. One goal for CXL is to provide a means for the Host to push operands into device-attached memory and for the Host to pull results out of device-attached memory such that it does not add software and hardware cost that offsets the benefit of the accelerator. Systems may include coherent system address-mapped device-attached memory, also referred to as HDM with Device Managed Coherence (HDM-D/HDM-DB). There is an important distinction between HDM and traditional I/O and PCIe Private Device Memory (PDM). An example of such a device is a GPGPU with attached GDDR. Such devices have treated device-attached memory as private. This means that the memory is not accessible to the Host and is not coherent with the remainder of the system. It is managed entirely by the device hardware and driver and is used primarily as intermediate storage for the device with large data sets. A disadvantage to a model such as this is that it involves high-bandwidth copies back and forth from the Host memory to device-attached memory as operands are brought in and results are written back. Please note that CXL does not preclude devices with PDM.

At a high level, there are two example approaches of resolving device coherence of HDM. The first uses CXL.cache to manage coherence of the HDM and is referred to as “Device coherent.” The memory region supporting this flow is indicated with the suffix of “D” (HDM-D). The second approach uses the dedicated channel in CXL.mem called Back Invalidation Snoop and is indicated with the suffix “DB” (HDM-DB). With HDM-DB, the protocol enables new channels in the CXL.mem protocol that allow direct snooping by the device to the host using a dedicated Back-Invalidation Snoop (BISnp) channel. The response channel for these snoops is the Back-Invalidation Response (BIRsp) channel. The channels allow devices the flexibility to manage coherence by using an inclusive snoop filter tracking coherence for individual cache lines that may block new M2S Requests until BISnp messages are processed by the host.

A CXL “Type 3” device supports CXL.io and CXL.mem protocols. An example of a CXL Type 3 Device is a memory expander for the Host. Since this is not a traditional accelerator that operates on host memory, the device does not make any requests over CXL.cache. A passive memory expansion device would use the HDM-H memory region and while not directly manipulating its memory while the memory is exposed to the host. The device operates primarily over CXL.mem to service requests sent from the Host. The CXL.io protocol is used for device discovery, enumeration, error reporting and management. The CXL.io protocol is permitted to be used by the device for other I/O-specific application usages. The CXL architecture is independent of memory technology and allows for a range of memory organization possibilities depending on support implemented in the Host. Type 3 device Memory that is exposed as an HDM-DB enables the device to directly manage coherence with the host to enable in-memory computing and direct access using UIO on CXL.io. A Type 3 Multi-Logical Device (MLD) can partition its resources into up to multiple (e.g., 16) isolated Logical Devices. Each Logical Device may be identified by a Logical Device Identifier (LD-ID) in CXL.io and CXL.mem protocols. Each Logical Device visible to a Virtual Hierarchy (VH) operates as a Type 3 device. The LD-ID is transparent to software. MLD components have common Transaction and Link Layers for each protocol across all LDs.

CXL is capable of maintaining memory coherency between the CPU memory space and memory on attached devices, so that any of the CPU cores or any of the other I/O devices configured to support CXL may utilize these attached memories and cache data locally on the same. Further, CXL allows resource sharing for higher performance, such that memory pooling may be achieved across different computing entities. Such CXL-enabled memory pools may enable enhanced and more efficient movement of operands. For instance, rather than utilizing DMA operation to transfer an entire segment of data from one computing element to the next computing element in association with a corresponding operation, coherent memory allows data to be moved seamlessly as if it were a simple transfer between the different cores in different CPU sockets. Such memory pooling can thus realize significant latency reduction and enable this aggregated memory in the system. Such features can enable more efficient memory usage, reduced architectural complexity, and thereby lower overall system costs. Further, such features allows programmers and system developers to focus on target workloads as opposed to redundant memory management, among other example benefits.

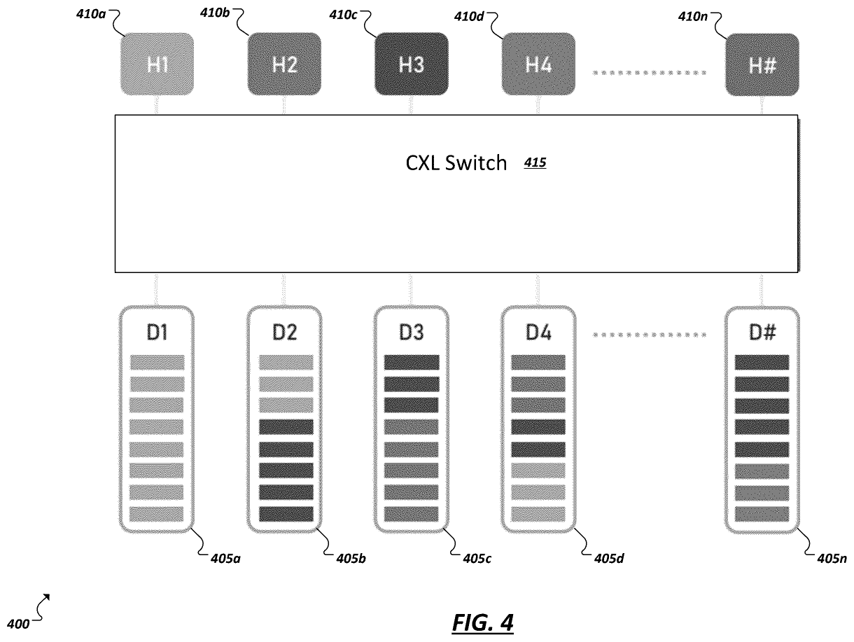

FIG. 4 is a simplified block diagram 400 illustrating the example pooling of multiple devices 405a-n (e.g., logical type 2 devices) to multiple host devices 410a-m. CXL (e.g., CXL 2.0) enables such pooling utilizing a CXL switch 415 (with a standardized CXL Fabric manager 418), where the memory on the devices 405a-n can be assigned to or shared with different hosts (e.g., 410a-m) and can be changed over time. The CXL switch 415 supports multiple hosts and is responsible for ensuring quality of service as well as isolation between different hosts. Other implementations, may utilize processing-in-memory (PIM) within their systems or cluster, including logic-in-memory or near-data processing. PIM technology aims to bring memory and computing closer instead of separating them, thus, improving the efficiency of data movement. Traditional PIM systems, however, may struggle with data coherence issues, as both a host processor and PIM processing can handle and compete for data, among other example issues.

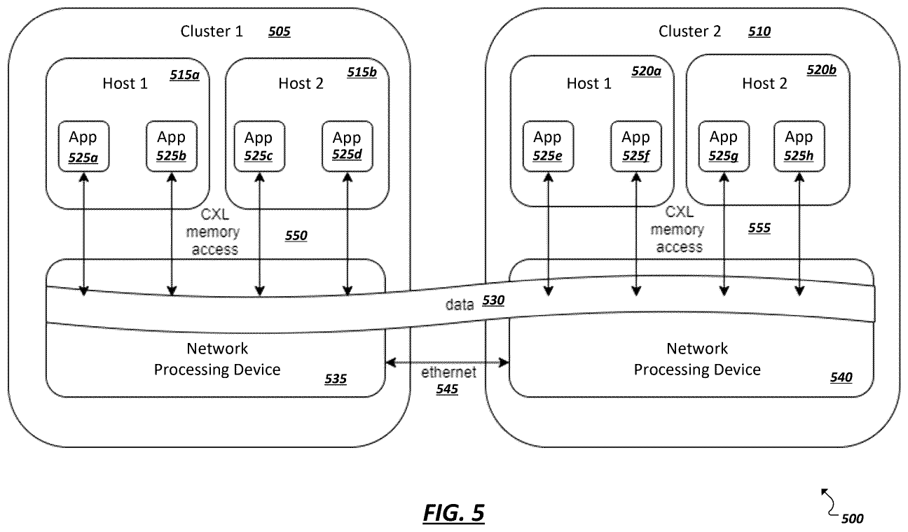

Improved node or cluster architectures may leverage the combined features of CXL and smart network processing devices (e.g., IPUs) to develop more efficient and better-performing service mesh clusters, which achieve these efficiencies with minimal movement of networking data and enhanced near memory processing. Such improved clusters can realize smaller latency, better resources utilization, and lower power consumption, among other example benefits. FIG. 5 is a simplified block diagram 500 illustrating a logical view of such a portion of such an improved cluster. As introduced above, a service mesh can be composed of one or multiple clusters (e.g., 505, 510). Host devices (e.g., 515a, 515b, 520a, 520b, etc.) may each host various programs, services, or applications (e.g., 525a-h), which are executed on the corresponding host and which may share and operate various data on the service mesh. All of the data 530 moving within the cluster may be handled using the corresponding cluster's network processing device (e.g., 535, 540), with the network processing device further handling the inter-cluster communications and the internal connections of hosts and the network processing device within the cluster. Attached memory of the network processing device may be utilized to implement a memory pool for the cluster. Accordingly, data used in transactions within the cluster may be saved in the memory pool on the network processing device. Accordingly, when host device accesses the data within a transaction, the host device can utilize CXL memory accesses (e.g., 550, 555) to directly read or write data through the CXL cached memory as if it were local memory.

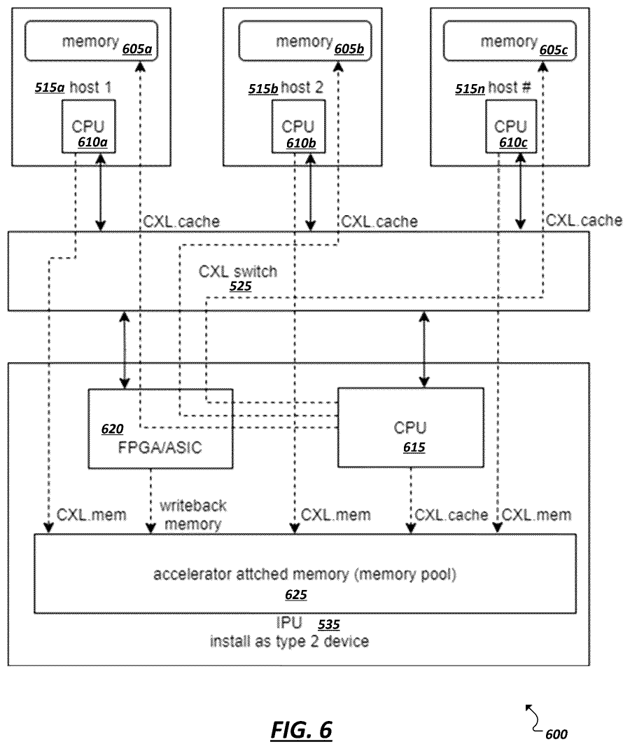

Turning to FIG. 6, a simplified block diagram 600 illustrating example hardware blocks of components within a cluster, such as the example shown in FIG. 5. For instance, each host device (e.g., 515a-n) may include respective local or attached memory (e.g., 605a-c) as well respective processing hardware 610a-c (e.g., CPU, FPGA, GPU, tensor processing unit (TPU), accelerator hardware, etc.), which may be utilized to host and execute various applications or portions of applications on the corresponding host. Each of the host devices 515a-c may be connected to a CXL switch 525 for the cluster. The network processing device 535 of the cluster is also coupled to the switch 525. The network processing device 535 may include both a CPU 615 and programmable processing block 620 (e.g., a field programmable gate array (FPGA) or application-specific integrated circuit (ASIC)), together with attached memory 625, at least a portion of which is designated for use as a memory pool for the cluster.

In one example implementation, the network processing device 535 may be installed as a CXL type 2 device. Accordingly, the CPUs (e.g., 610a-c) of the hosts 515a-c, as well as the CPU (e.g., 615) of the network processing device 535, can cache (e.g., perform cacheable reads and cacheable writes of) the attached memory of the network processing device 535 using the CXL.mem subprotocol. The programmable processing block 620 of the network processing device 535 may cache the hosts' attached memory (e.g., 605a-c) using the CXL.cache subprotocol. Further, a dedicated hardware channel may be provided between the CPU 615 and programmable processing block 620 of the network processing device 535, allowing the CPU 615 to access the hosts' memories (e.g., 605a-c) through the programmable processing block 620 (e.g., also using the CXL.cache subprotocol), among other example features and implementations.

Some devices (e.g., I/O devices (e.g., CXL devices, PCIe, UCIe devices)) may include multiple ports and accompanying logic to support connections to multiple interconnects, where each of these multiple interconnects may support an independent link according to a corresponding interconnect protocol. Likewise, each individual port may include circuitry and other logic to implement layers of a protocol stack to implement a link on one of the multiple interconnects. In the case of a CXL-based port, the port may support two or more the CXL protocols (e.g., CXL.io, CXL.cache, and CXL.mem). Such functionality may, for instance, allow the device to couple to multiple other devices, with each interconnect bus (e.g., a grouping of physical lanes (e.g., x8, x16, etc.) available for use in implementing at least one link) used to connect the device to a respective one of the other devices. The respective width of each of these ports (e.g., with a number of pins or contacts corresponding to the lane width of a corresponding bus) may potentially limit the bandwidth of data over the bus and any links established on the bus. In some implementations, link aggregations may be utilized to effectively combine the bandwidth offered by two or more individual interconnects to meet the higher performance or bandwidth targets of a given applications. For instance, a device may leverage the multiple ports (coupled to multiple interconnects) to create an aggregated, or bundled, port and corresponding aggregated link. Prior to link aggregation, previous solutions to address bandwidth constraints typically involved using multiple discrete CXL links, each managed independently, which could lead to inefficiencies in data routing and increased complexity in managing multiple connections. Additionally, traditional methods might involve using higher bandwidth single links, which can be cost-prohibitive and may not fully utilize the potential of existing infrastructure.

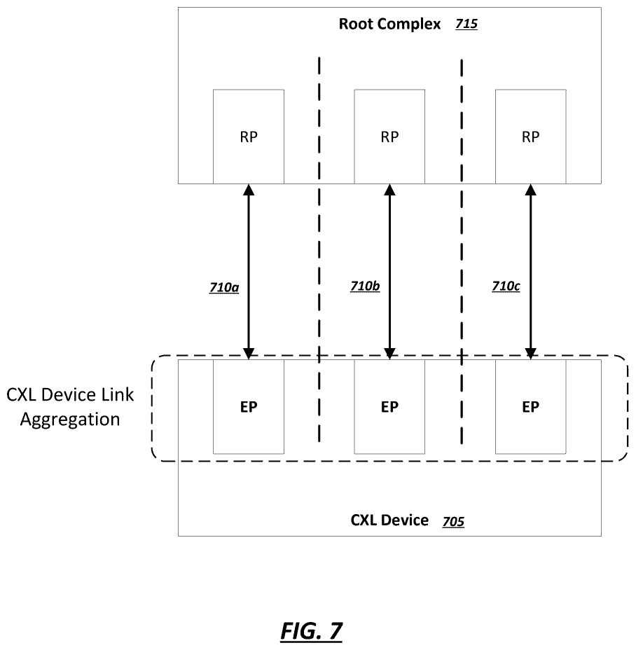

Within the context of PCIe, CXL, and other interconnect protocols, link aggregation may involve bonding multiple physical links between a host (e.g., a CPU) and an I/O device of the protocol (e.g., a memory expander, hardware accelerator device, etc.) to function as a single, higher-bandwidth logical link (e.g., aggregated from the viewpoint of the I/O device). Link aggregation may be beneficially implemented on an application-by-application basis such that multiple interconnects or link may be aggregated for one workload and separated for other workloads. FIG. 7 is a simplified block diagram illustrating an example I/O device 705 with multiple ports to support multiple links 710a-c to couple the I/O device 705 to one or more other devices (e.g., device 715). The multiple links 710c can be aggregated to function logically as a higher-bandwidth link for use in increasing data throughput (e.g., by spreading traffic across multiple links), improve redundancy (e.g., if implemented with failover or fault tolerance), to balance workloads (e.g., between multiple CXL devices or interfaces), among other example benefits and implementations.

Modern protocols may lack standardized protocol rules and mechanism for integration into corresponding protocol circuitry to effectively aggregate multiple links (e.g., CXL links), which may be necessary to overcome the bandwidth limitations of single-link connections. Without defined behaviors and protocol definitions for link aggregation, a risk of inefficiencies, data inconsistencies, and suboptimal performance may result. For instance, in the case of CXL, where multiple sub-protocols (e.g., CXL.io, CXL.cache, CXL.mem) are defined, various issues may exist in aggregating links in each of these respective sub-protocols. In an improved implementation, protocol enhancements may be defined for link aggregation, and corresponding protocol logic may be defined to ensure seamless integration and operation of aggregated links, thereby enhancing data throughput and scalability while maintaining the integrity and efficiency of link operations. In one example implementation, link aggregation rules may be defined for the three CXL sub-protocols, enabling a CXL device to connect to multiple root or switch ports simultaneously (as shown in the example of FIG. 7). This aggregated connection expands the data path, effectively increasing bandwidth and optimizing data flow across CXL protocols (CXL.io, CXL.cache, CXL.mem), thereby enhancing performance and scalability. Such an enhancement drives the C×L ecosystem forward by enabling link aggregation, which significantly scales bandwidth and enhances data throughput. This capability may allow for more efficient utilization of existing infrastructure, supports high-performance computing needs, and provide customers with improved scalability and flexibility in data-intensive applications, among other example benefits.

Link aggregation combines multiple individual links into a single logical link, effectively expanding the data path and increasing bandwidth. CXL is an open standard designed to improve data center performance by facilitating high-speed communication between CPUs, accelerators, memory, and other devices. CXL includes three sub-protocols: CXL.io, CXL.cache, and CXL.mem. To fully leverage link aggregation within the CXL framework, link aggregation rules can be defined and standardized for these sub-protocols. These protocol rules ensure interoperability and consistency between the connected entities.

Link aggregation combines multiple individual links into a single logical link, effectively expanding the data path and increasing bandwidth. Compute Express Link (CXL) is an open standard designed to improve data center performance by facilitating high-speed communication between CPUs, accelerators, memory, and other devices. CXL includes three sub-protocols: CXL.io, CXL.cache, and CXL.mem. To fully leverage link aggregation within the CXL framework, link aggregation rules can be defined and standardized for these sub-protocols. These protocol rules ensure interoperability and consistency between the connected entities. While the below examples are centered around the example of CXL and the characteristics of the CXL sub-protocols, it should be appreciated that the principles and implementations outlined below may be applied to other, non-CXL protocols, such as protocols with features and characteristics similar to any one of CXL.io, CXL.cache, or CXL.mem, offering a standardized approach to link aggregation across various technologies and enhancing data throughput, scalability, and reliability, ultimately benefiting data-intensive applications and workloads.

A bundled port may contain any combination of standard full capability and streamlined ports. Streamlined ports may be implemented as lightweight ports designed to expand the data path and adapted particularly for a particular operation mode (e.g., for a specific flit mode (e.g. 256B flit mode)). In some cases, the streamlined ports may not support any other operating mode (e.g., 68B flit mode) or be fully backward compatible. A streamlined port may be advantageously provided and primarily used in bundled ports to simply expand the data path bandwidth, increasing the overall throughput capabilities of the connection, while reducing the hardware implementation cost by eliminating logic for alternative operating modes (e.g., support for other flit modes) along with any features exclusive to such alternative modes. As such, when bundling two or more ports of a device together as a bundled port, providing at least one full capability port in the group allows full backward compatibility and support of alternate flit modes and modes of operations, even where the remaining ports in the bundle are streamlined ports. As another example, streamlined ports may be permitted to support reduced bandwidth for standard CXL.io VC0 traffic. In some implementations, the simplified nature of a streamlined port allows non-upstream I/O (UIO) VC0 traffic on CXL.io, but it is a streamlined port may not be optimized for such traffic. Consequently, it may also be beneficial to provide at least some standard full capability ports in a bundle with streamlined ports to transmit non-UIO traffic, among other example considerations.

Devices and switches with ports which support port bundling may advertise support of this feature through a respective register (e.g., DVSEC register). For instance, bundled ports may be supported for CXL Type 1 and Type 2 devices which rely on device specific software for configuration/control, among other examples. Each respective port in a bundle may negotiate independently from other ports of the bundled port, including training to a different respective speed or link width and implementing separate port-specific capabilities and controls, among other example features.

In some implementations, a downstream port connected to an open slot may be expected to provide full backward compatibility, and thus would not be implemented using only streamlined ports. A downstream port that is part of a closed system is permitted to eliminate unnecessary backward compatibility support. An upstream port that is meant to be bundled with other ports may be permitted to be optimized as a streamlined port when at least one other port in the bundle provides full backward compatibility. Ports that are meant to be bundled together may be identified, in some implementations, through matching bundle identifier fields encoded with a register (e.g., in the Bundled Ports DVSEC).

Software may be provided (e.g., through port registers) with a view to the enumeration of ports on the devices in a system, as well as the bundling of ports within the system. Software enumeration of a streamlined port may follow the same enumeration flow as for standard ports. The devices or entities implementing a given bundled port may be capable of interleaving requests across these ports for optimal performance (e.g., at the direction of software, which includes logic for managing and directing such interleaving). In cases where a software or driver is bundled-port-unaware, the software may treat a bundled port device (implementing a bundle with two or more of its ports) as a set of independent CXL endpoints and may not be aware of the interdependencies and P2P traffic between various bundled port device endpoints. A bundled port device may be equipped with resources to guide or otherwise interoperate with such software to prevent issues (e.g. using a different device ID to prevent legacy, bundled-port-unaware drivers from managing the device), among other examples.

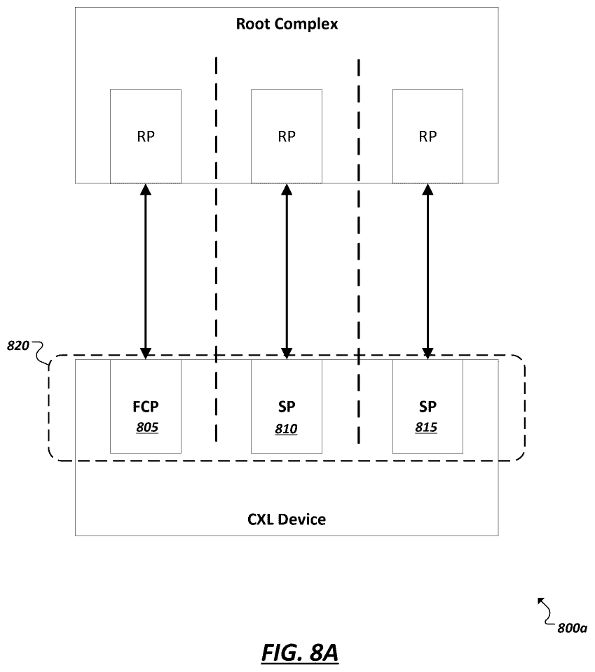

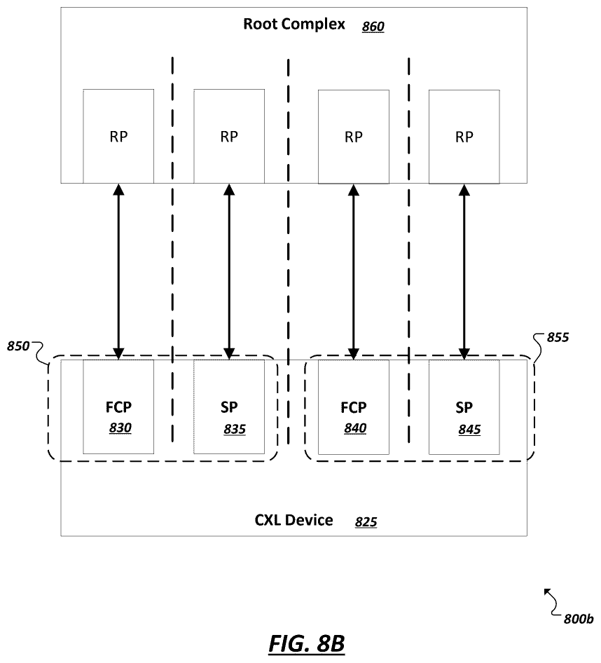

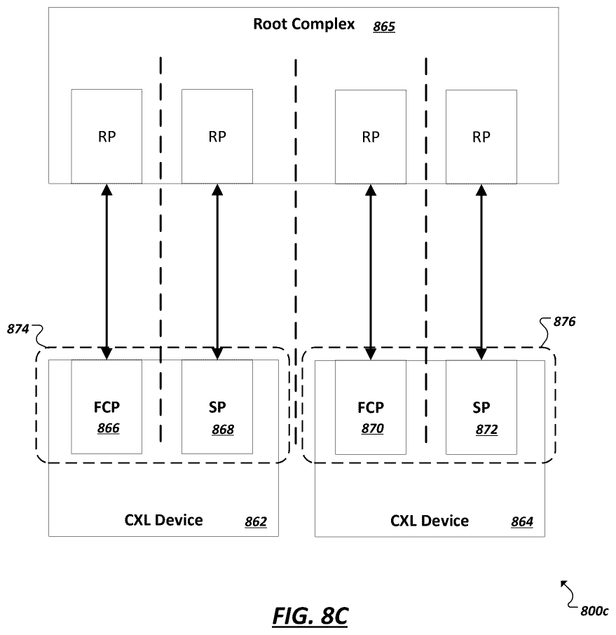

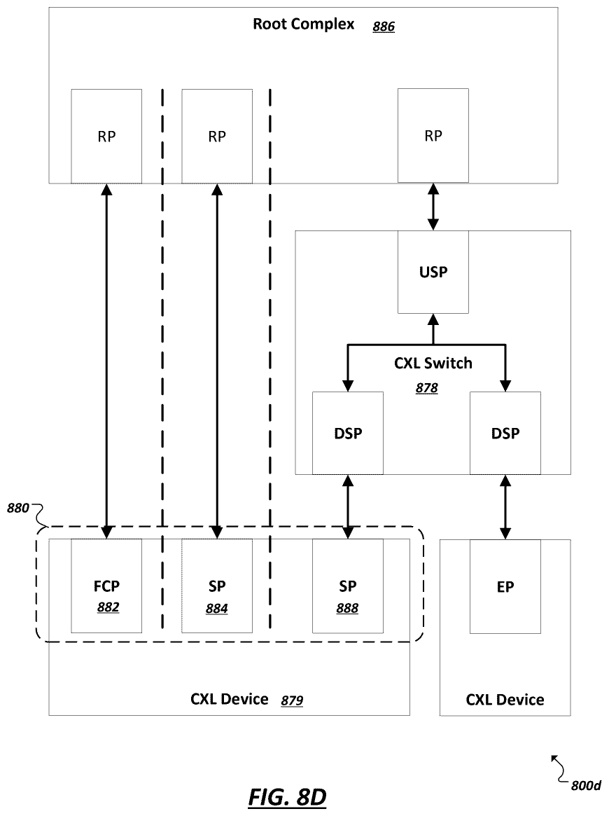

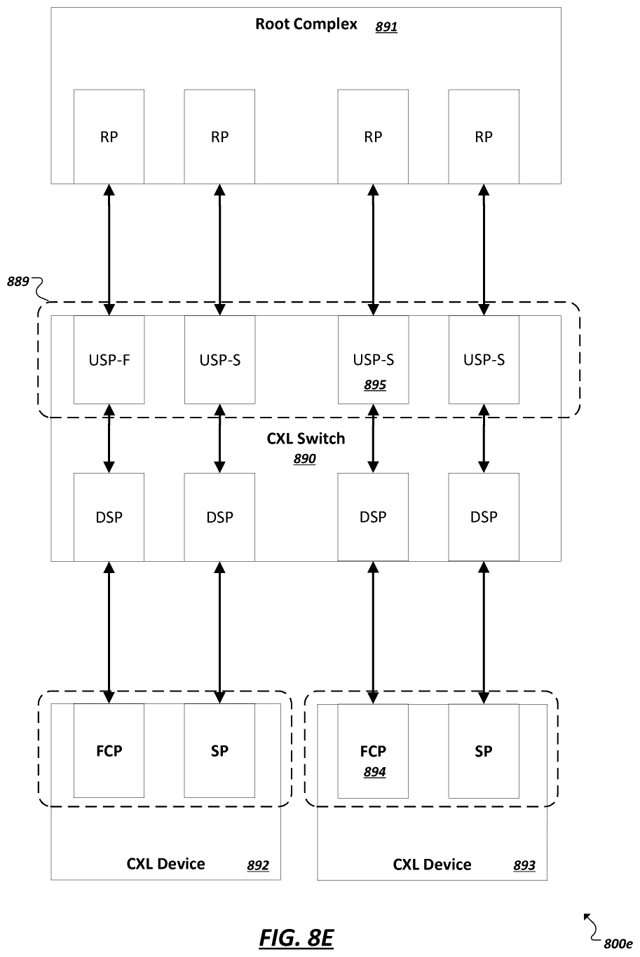

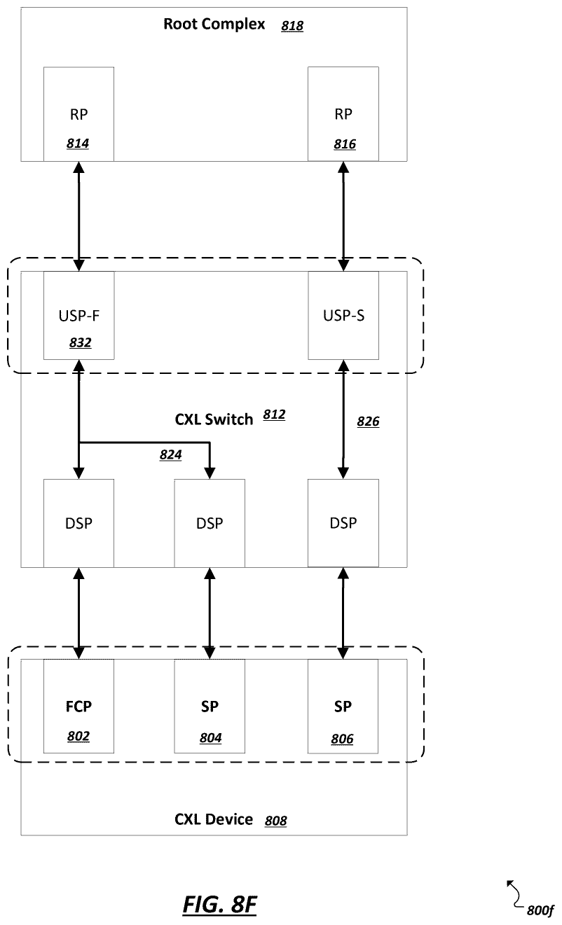

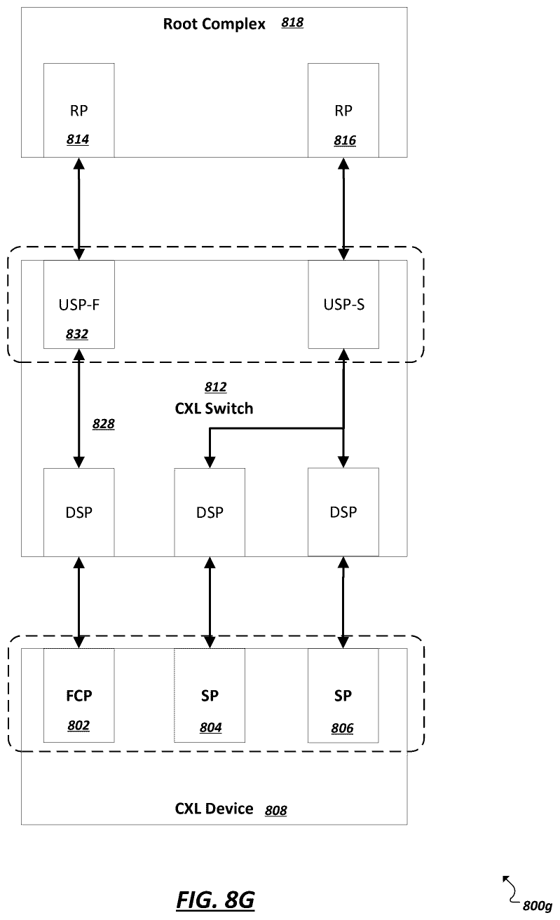

Various topologies may be adopted when implementing bundled ports in a system. FIGS. 8A-8G are simplified block diagrams 800a-800g showing example topologies, which may be adopted in some implementations. In some implementations, a topology may utilize a single standard full capability port (e.g., 805) in a bundled port 820 with full backward compatibility together with multiple streamlined ports (e.g., 810, 815) which are an optimized subset of the functionality as shown in the example of FIG. 8A. Such a topology may be useful, for instance, for devices that require the consistent performant transfer of both ordered and unordered traffic, as the fully capable port can efficiently handle the ordered traffic with the support of the additional bandwidth provided by the streamlined ports for the unordered and CXL.cache/CXL.mem traffic, among other example applications and benefits. In other cases, for instance, where most of the expected traffic through a bundled port is unordered, or the performance of ordered traffic is not critical, the bundled port (e.g., 820) may be configured instead with only streamlined ports (e.g., where a port is a streamlined port instead of a standard full capability port).

In the example of FIG. 8B, another example topology is shown, where a device (e.g., 825) segments its available ports (e.g., 830, 835, 840, 845) to form multiple bundled ports (e.g., 850, 855) when interfacing with the same entity (e.g., 860) on the other side of the links. This allows the device 825 to partition its resources and split the physical device into multiple bundled logical devices. In this scenario, each bundled port (e.g., 850 and 855) acts independently of the other bundled ports of the device. In the example topology illustrated in FIG. 8C, multiple devices (e.g., 862, 864) are connected to a single link partner device 865 (e.g., a root complex), with each of the two or more device 862, 864 respectively aggregating their ports (e.g., 866, 868, 870, 872) to form their own bundled port (e.g., 874, 876). In yet another example topology, shown in FIG. 8D, one or more switches (e.g., 878) may be provided through which a device (e.g., 879) with a bundled port 880 is connected to different entities, where two ports (e.g., 882, 884) in the bundle 880 connect directly to a root complex (e.g., 886), and a third port (e.g., 888) in the bundle connects to a switch 878.

The inclusion of one or more switches in a topology may be leveraged to realize efficiencies for certain expected types of traffic. Routing and connectivity at a switch with bundled port support may be configured to account for the specific requirements of the workload and expected usages. Turning to the example topology of FIG. 8E, a single bundled port (e.g., 889) connecting the switch 890 to the root complex 891, and multiple devices (e.g., 892, 893) connected downstream of the switch 890. In this topology, the switch 890 maps each port connected to a device individually to a port connected to the Root Complex. In this example, a standard full capability port (e.g., 894) from device 893 is routed through to a streamlined port (e.g., 895) connected to the root complex 891. While in this example, a balanced number of upstream ports (e.g., between the switch and the root complex) and downstream ports (e.g., between the switch and the devices (e.g., 892, 893)) are provided, in other cases a switch may have an imbalanced number of upstream ports and downstream ports may be provided (e.g., with fewer upstream ports than downstream ports or fewer downstream ports than upstream ports, etc.). For instance, in an example where more full capability ports are on downstream devices than are available at the upstream device (e.g., root complex), multiple full capability ports on downstream devices may be routed through a singular standard port in the upstream direction (e.g., to beneficially handle substantial ordered traffic from either device), among other examples. For instance, turning to the example topology shown in FIG. 8F, an imbalanced number of ports (e.g., three device ports 802, 804, 806) are provided on device 808, which connects through switch 812, to two root complex ports 814, 816 (on root complex 818). In this example, rather than targeted optimization of ordered traffic, the topology may be configured to distribute the two downstream streamlined ports (e.g., 804, 806) across separate upstream paths (e.g., 824, 826) via the switch 812, for instance, to maximize the utilization of available ports for scenarios where ordered traffic is less significant or not critical to the workload. FIG. 8G shows another version of the topology of FIG. 8F, where the switch 812 is instead configured to prioritize the standard full capability port (e.g., 802) of the device 808, defining routing to provide the full capability port (e.g., 802) with a dedicated route (e.g., 828) through the switch (e.g., via upstream port 832) to the full capability port (e.g., 832) of the root complex 818. This routing ensures that ordered traffic has a dedicated full bandwidth pathway route from the device s it ensures the device's standard full capability port 802 to the root complex's standard full capability port 832, among other examples.

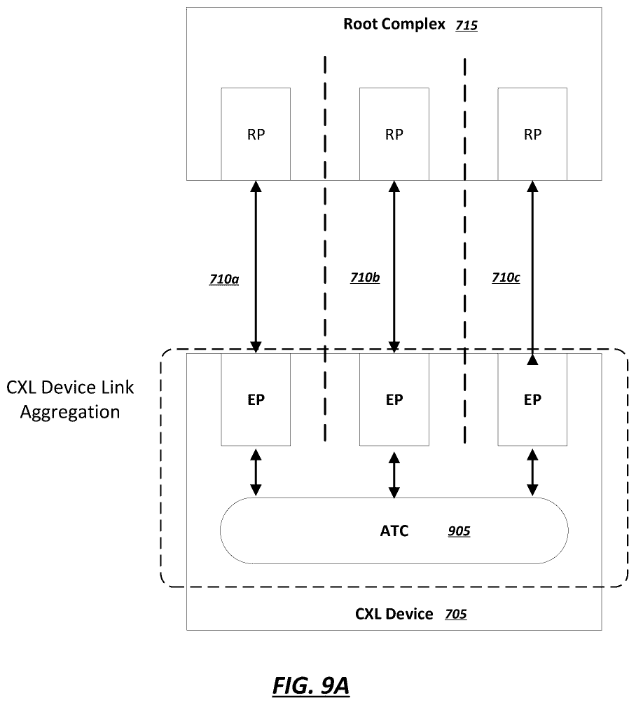

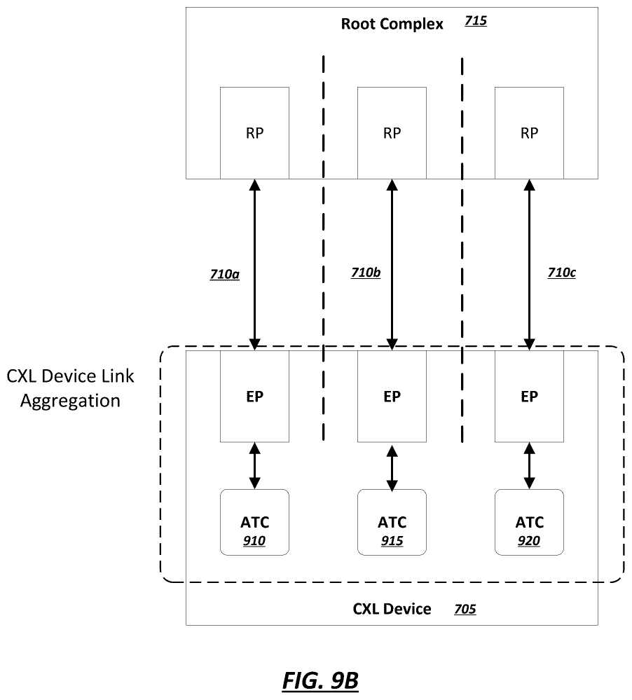

Enabling link bundling, or link aggregating, to logically combine the interconnects of two or more ports to function as a single logical port, may beneficially increase the effective bandwidth of a channel between two devices, but such aggregating may complicate the management of various protocol resources defined for use within a given interconnect protocol (or set of interconnect protocols (e.g., CXL-based protocols CXL.io, CXL.cache, CXL.mem)). For instance, link partner devices (e.g., host devices or switches) may not have visibility into the manner in which a bundled link is formed and implemented on an I/O device. Examples of protocol resources may include address translation resources (e.g., address translation caches) and mapping address translations corresponding to individual links in the bundled link to address translation resources, memory caches and cache coherency management resources and mapping coherency transactions to individual links in the bundled link, among other examples. Tracking logic may be implemented in association with ports included in a bundled port to track requests and utilize the appropriate protocol resources associated with a given port, among other examples. For instance, in the example of CXL.io (or PCIc), Address Translation Services (ATS) for I/O devices may be provided to enable efficient translation of virtual addresses to physical addresses. CXL.io inherits ATS definitions from PCIe, allowing devices to request address translations from the host. In turn, the I/O device may maintain an address translation cache (ATC) to cache these translations locally to be used on subsequent transfers. This process optimizes data transfer by reducing the overhead associated with repeated address translations. For instance, as shown in FIGS. 9A-9B, one or more ATCs (e.g., 905, 910, 915, 920, etc.) may be provided on an I/O device 705. In a link aggregation scenario, a device can implement ATS using either a shared ATC (e.g., 905), such as shown in the example of FIG. 9A, or a split ATC (e.g., 910, 915, 920) across multiple links. In the case of a shared ATC, the device 705 may maintain a single cache 905 for translated addresses, accessible by any of the individual links (when operating in a non-aggregated mode) or all aggregated links (during link aggregation of the individual links). This approach allows translated addresses to be used interchangeably across links, simplifying management and potentially improving performance. However, it requires careful coordination to ensure consistency and proper invalidation across all links. In this case of split ATC, such as shown in the example of FIG. 9B, a device can alternatively (or additionally) maintain separate ATCs 910, 915, 920 for each respective link (e.g., 710a-c). In this mode, translated addresses are specific to the link that requested them, which can help isolate address translation processes, but may lead to redundancy and increased complexity in managing multiple caches.

As noted above, ATS invalidations are critical for maintaining the integrity of address translations. When address remappings occur or a function no longer has access to a cached range, invalidations must be propagated to ensure that outdated translations are not used. In some implementations, ATS validations can be implemented using single representative link invalidation. For instance, software can send ATS invalidations on one representative link, with the device responsible for ensuring that the invalidation affects all associated links. This approach simplifies software operations, but involves robust device logic to maintain proper ordering and consistency. In another implementation, separate invalidation may be performed for each link, with software issuing separate ATS invalidations for each link, ensuring that each link independently processes the invalidation. While this approach simplifies ordering and consistency management, it may lead to redundant invalidations, impacting performance if the rate of invalidations is high. The choice between these approaches depends on the device's implementation and the software configuration. Properly managing ATS behavior and address translation across aggregated links is essential to optimizing performance and preventing issues such as I/O translation lookaside buffer (IOTLB) thrashing, ensuring efficient operation of CXL.io in link aggregation scenarios, among other example considerations and features.

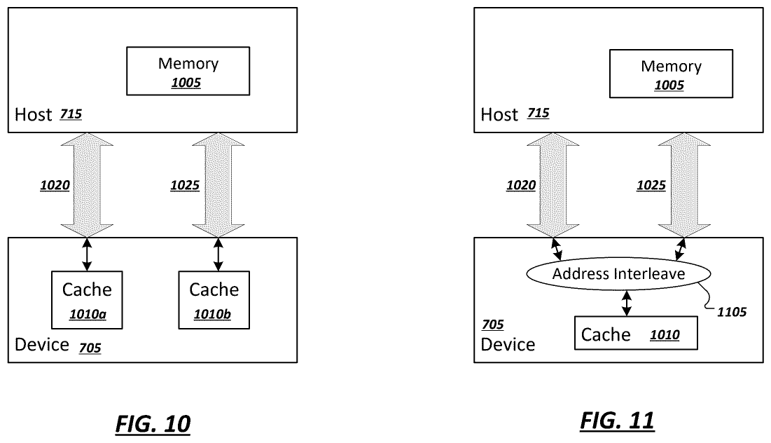

As shown in the examples of FIGS. 10-11, for CXL.cache, link aggregation can complicate the snooping and cache line management involved in maintaining cache coherency from the device to the host (e.g., where the device 705 is able to access and cache CPU memory 1005 of the host 715). For instance, a host device is responsible for tracking device caching of each link independently and may include circuitry to track coherency at each of the link. As a result, the device 705 shall remember the link used to send a cacheable request and respond to snoops and send Evictions only on the link which sent the cacheable request. If the device 705 receives a snoop for an address that is cached, but the snoop was not from a link which issued the request, the device 705 shall respond with a no-hit snoop response (e.g., RspIHitI response in CXL) and shall not impact the state of the cache. Note that snooping from the host on the link which did not send the request may occur if the host has imprecise coherence tracking. For non-caching requests that do not change cache state to the device (e.g., RdCur, ItoMWr), the device may issue the requests on any link while following the buried cache state rules relative to that link where the request is issued. A CacheFlushed command shall be sent on each link independently to indicate to the host 715 that no more caching is associated with that corresponding link.

In some implementations, a device 705 may implement a respective cache (e.g., 1010a-b) for each respective link (e.g., 1020, 1025), such as shown in the example of FIG. 10. In other implementations, a device 705 may implement a common cache (e.g., 1010), such as shown in FIG. 11, where the common cache 1010 is shared for CXL.cache transactions across the multiple links (e.g., 1020, 1025). In the case of separate caches, such as shown in the example of FIG. 10, a separate cache (e.g., 1010a,b) per link may be maintained by the device 705, where cacheable requests are sent to a single link and affinitized to the corresponding cache. Snoops from that link are accordingly also processed only by the cache assigned to that link. In the example of FIG. 11, a common cache 1010 per device is maintained along with address interleave circuitry (e.g., 1105) to implement static interleaving based on address for routing requests to upstream ports. In the example of a common cache, snoops received from a link which is not assigned the address are to always return a RspIHitI and not change the cache state. The address interleaving scheme in this model is up to the device and is to be assigned before any CXL.cache traffic is active and must remain static. Further, the ID spaces for CXL.cache (e.g., CacheID, UQID, SQID) are to be unique only to the link where the request originated. All Responses and Data shall return to the link which sent the request.

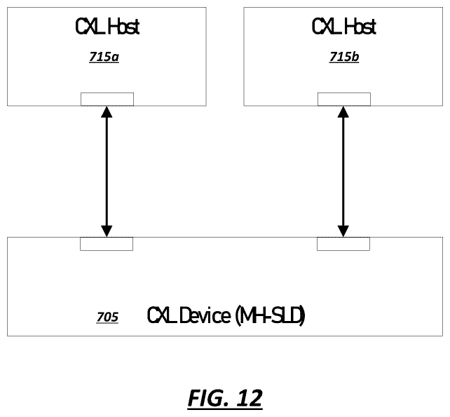

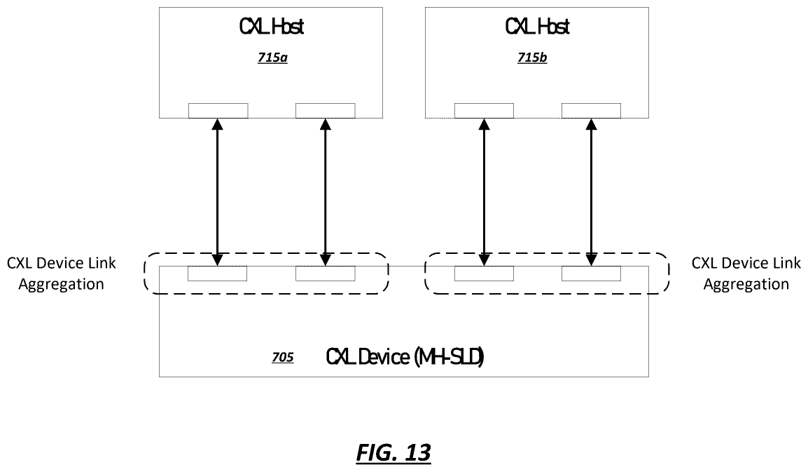

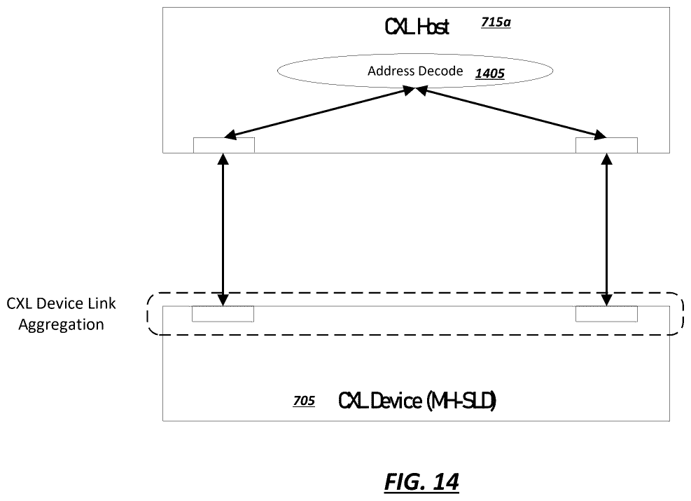

Turning to FIGS. 12-14, in the case of CXL.mem, a host device (e.g., 715a, 715b, etc.) is permitted to access and cache the memory of the I/O device 705 to which it is connected via a CXL link in a coherent manner. The hosts may manage the host-to-device coherency according to the CXL.mem protocol. For instance, the I/O device may be implemented as a Multi-Headed Device within the CXL framework, where the device 705 is a Type 3 device equipped with multiple CXL ports, each referred to as a “head.” These devices (e.g., 705) can be categorized into two types based on what's behind each head: a Multi-Headed Single Logical Device (MH-SLD) or a Multi-Headed Multi Logical Device (MH-MLD). FIG. 12 illustrates an implementation of a MH-SLD device 705 connected to two hosts 715a, 715b using two corresponding ports (and links). This setup demonstrates the capability of MH-SLDs to interface with multiple hosts simultaneously. Indeed, MH-SLDs may be designed to function when multiple heads/ports are connected to the same host. As shown in the example of FIG. 13, the links coupling an MH-SLD device 705 to the respective hosts 715a, 715b may be capable of being aggregated or bundled (e.g., where the MH-SLD device 705 connects to two hosts 715a,b, utilizing two heads/ports for each host, as shown in the example of FIG. 13). In scenarios such as this, where a single host (e.g., 715a) connects to an MH-SLD (e.g., 705) using a bundled link (e.g., 1315) created through multiple heads/ports (e.g., 1305, 1310), the host (e.g., 715a) determines which head/port to route CXL.mem requests to using address decode and interleave circuitry (e.g., 1405), as depicted in FIG. 14. This requires the Type 3 device to track each link independently, even when connected to the same host. Similarly, the host must remember which link it sent the request on to ensure proper routing and coherence.

Continuing with the example of FIGS. 13-14, protocol rules of CXL.mem may be enhanced to which both the device (e.g., 705) and host (e.g., 715a,b) are to adhere. For instance, a request tracking rule may be defined, where both the device and host are required to track and remember the given one of the aggregated links used to send requests. This tracking may be used to maintain coherence at the host and ensure that subsequent operations are correctly routed. Additionally, the device 705 may be required to send any Back Invalidate snoops on the link that originally sent the corresponding request. This ensures that invalidation operations are correctly targeted and do not disrupt other links. Further, snoop responses of the host (e.g., 715a,b) to a given snoop are to be sent only from the link that sent the snoop request. If the host receives a snoop for an address that is cached, but the snoop was not sent from the link that issued the request, the host must not update the state of the cache. This prevents unintended cache state changes and maintains data consistency. By implementing these example protocol rules, MH-SLDs can effectively manage memory operations across multiple links, whether connected to the same host or different hosts, ensuring efficient and coherent memory access in complex multi-link environments.

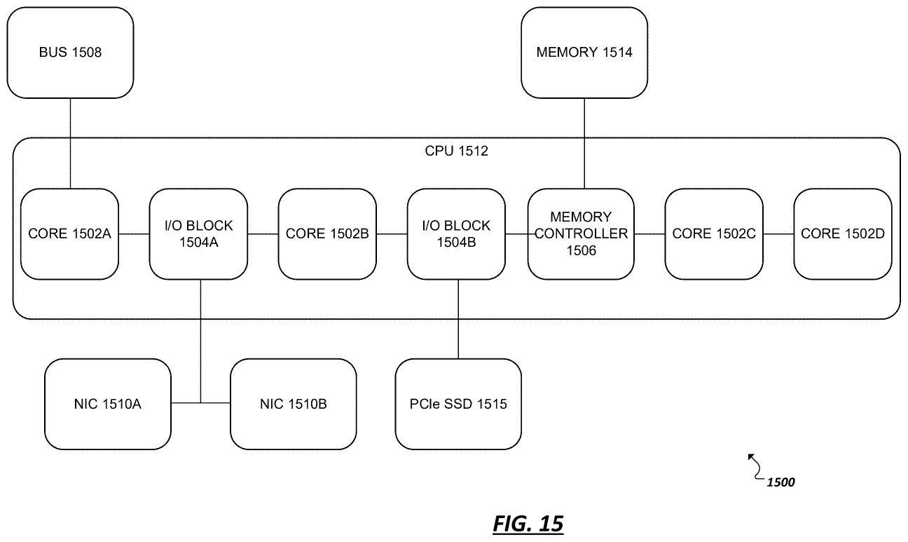

While the examples above pertain to CXL-based protocols, it should be appreciated that these examples are presented to illustrate more generalized principles and features, which may be applied to other interconnect protocols including PCIe, NVLink, Universal Chiplet Interconnect Express (UCIe), Ultra Path Interconnect (UPI), Infinity Fabric, among other example protocols. Note further that the apparatus', methods', and systems described above may be implemented in any electronic device or system as aforementioned. As a specific illustration, FIG. 15 provides an exemplary implementation of a processing device such as one that may be included in a network processing device. It should be appreciated that other processor architectures may be provided to implement the functionality and processing of requests by an example network processing device, including the implementation of the example host and/or I/O device components and functionality discussed above. Further, while the examples discussed above focus enhancements to the CXL protocol, it should be appreciated that references to CXL and CXL-based ports, devices, and systems are provided as an illustrative example only. Indeed, the more generalized concepts disclosed herein may be equally and advantageously applied to other interconnects and interconnect protocols that facilitate similar resource pooling, among other examples.

Referring to FIG. 15, a block diagram 1500 is shown of an example data processor device (e.g., a central processing unit (CPU)) 1512 coupled to various other components of a platform in accordance with certain embodiments. Although CPU 1512 depicts a particular configuration, the cores and other components of CPU 1512 may be arranged in any suitable manner. CPU 1512 may comprise any processor or processing device, such as a microprocessor, an embedded processor, a digital signal processor (DSP), a network processor, an application processor, a co-processor, a system on a chip (SOC), or other device to execute code. CPU 1512, in the depicted embodiment, includes four processing elements (cores 1502 in the depicted embodiment), which may include asymmetric processing elements or symmetric processing elements. However, CPU 1512 may include any number of processing elements that may be symmetric or asymmetric.

In one embodiment, a processing element refers to hardware or logic to support a software thread. Examples of hardware processing elements include: a thread unit, a thread slot, a thread, a process unit, a context, a context unit, a logical processor, a hardware thread, a core, and/or any other element, which is capable of holding a state for a processor, such as an execution state or architectural state. In other words, a processing element, in one embodiment, refers to any hardware capable of being independently associated with code, such as a software thread, operating system, application, or other code. A physical processor (or processor socket) typically refers to an integrated circuit, which potentially includes any number of other processing elements, such as cores or hardware threads.

A core may refer to logic located on an integrated circuit capable of maintaining an independent architectural state, wherein each independently maintained architectural state is associated with at least some dedicated execution resources. A hardware thread may refer to any logic located on an integrated circuit capable of maintaining an independent architectural state, wherein the independently maintained architectural states share access to execution resources. As can be seen, when certain resources are shared and others are dedicated to an architectural state, the line between the nomenclature of a hardware thread and core overlaps. Yet often, a core and a hardware thread are viewed by an operating system as individual logical processors, where the operating system is able to individually schedule operations on each logical processor.

Physical CPU 1512, as illustrated in FIG. 15, includes four cores-cores 1502A, 1502B, 1502C, and 1502D, though a CPU may include any suitable number of cores. Here, cores 1502 may be considered symmetric cores. In another embodiment, cores may include one or more out-of-order processor cores or one or more in-order processor cores. However, cores 1502 may be individually selected from any type of core, such as a native core, a software managed core, a core adapted to execute a native Instruction Set Architecture (ISA), a core adapted to execute a translated ISA, a co-designed core, or other known core. In a heterogeneous core environment (e.g., asymmetric cores), some form of translation, such as binary translation, may be utilized to schedule or execute code on one or both cores.

A core 1502 may include a decode module coupled to a fetch unit to decode fetched elements. Fetch logic, in one embodiment, includes individual sequencers associated with thread slots of cores 1502. Usually a core 1502 is associated with a first ISA, which defines/specifies instructions executable on core 1502. Often machine code instructions that are part of the first ISA include a portion of the instruction (referred to as an opcode), which references/specifies an instruction or operation to be performed. The decode logic may include circuitry that recognizes these instructions from their opcodes and passes the decoded instructions on in the pipeline for processing as defined by the first ISA. For example, as decoders may, in one embodiment, include logic designed or adapted to recognize specific instructions, such as transactional instructions. As a result of the recognition by the decoders, the architecture of core 1502 takes specific, predefined actions to perform tasks associated with the appropriate instruction. It is important to note that any of the tasks, blocks, operations, and methods described herein may be performed in response to a single or multiple instructions; some of which may be new or old instructions. Decoders of cores 1502, in one embodiment, recognize the same ISA (or a subset thereof). Alternatively, in a heterogeneous core environment, a decoder of one or more cores (e.g., core 1502B) may recognize a second ISA (either a subset of the first ISA or a distinct ISA).

In various embodiments, cores 1502 may also include one or more arithmetic logic units (ALUs), floating point units (FPUs), caches, instruction pipelines, interrupt handling hardware, registers, or other suitable hardware to facilitate the operations of the cores 1502.

Bus 1508 may represent any suitable interconnect coupled to CPU 1512. In one example, bus 1508 may couple CPU 1512 to another CPU of platform logic (e.g., via UPI). I/O blocks 1504 represents interfacing logic to couple I/O devices 1510 and 1515 to cores of CPU 1512. In various embodiments, an I/O block 1504 may include an I/O controller that is integrated onto the same package as cores 1502 or may simply include interfacing logic to couple to an I/O controller that is located off-chip. As one example, I/O blocks 1504 may include PCIe interfacing logic. Similarly, memory controller 1506 represents interfacing logic to couple memory 1514 to cores of CPU 1512. In various embodiments, memory controller 1506 is integrated onto the same package as cores 1502. In alternative embodiments, a memory controller could be located off chip.

As various examples, in the embodiment depicted, core 1502A may have a relatively high bandwidth and lower latency to devices coupled to bus 1508 (e.g., other CPUs 1512) and to NICs 1510, but a relatively low bandwidth and higher latency to memory 1514 or core 1502D. Core 1502B may have relatively high bandwidths and low latency to both NICs 1510 and PCIe solid state drive (SSD) 1515 and moderate bandwidths and latencies to devices coupled to bus 1508 and core 1502D. Core 1502C would have relatively high bandwidths and low latencies to memory 1514 and core 1502D. Finally, core 1502D would have a relatively high bandwidth and low latency to core 1502C, but relatively low bandwidths and high latencies to NICs 1510, core 1502A, and devices coupled to bus 1508.

“Logic” (e.g., as found in I/O controllers, power managers, latency managers, etc. and other references to logic in this application) may refer to hardware, firmware, software and/or combinations of each to perform one or more functions. In various embodiments, logic may include a microprocessor or other processing element operable to execute software instructions, discrete logic such as an application specific integrated circuit (ASIC), a programmed logic device such as a field programmable gate array (FPGA), a memory device containing instructions, combinations of logic devices (e.g., as would be found on a printed circuit board), or other suitable hardware and/or software. Logic may include one or more gates or other circuit components. In some embodiments, logic may also be fully embodied as software.

A design may go through various stages, from creation to simulation to fabrication. Data representing a design may represent the design in a number of manners. First, as is useful in simulations, the hardware may be represented using a hardware description language (HDL) or another functional description language. Additionally, a circuit level model with logic and/or transistor gates may be produced at some stages of the design process. Furthermore, most designs, at some stage, reach a level of data representing the physical placement of various devices in the hardware model. In the case where conventional semiconductor fabrication techniques are used, the data representing the hardware model may be the data specifying the presence or absence of various features on different mask layers for masks used to produce the integrated circuit. In some implementations, such data may be stored in a database file format such as Graphic Data System II (GDS II), Open Artwork System Interchange Standard (OASIS), or similar format.

In some implementations, software-based hardware models, and HDL and other functional description language objects can include register transfer language (RTL) files, among other examples. Such objects can be machine-parsable such that a design tool can accept the HDL object (or model), parse the HDL object for attributes of the described hardware, and determine a physical circuit and/or on-chip layout from the object. The output of the design tool can be used to manufacture the physical device. For instance, a design tool can determine configurations of various hardware and/or firmware elements from the HDL object, such as bus widths, registers (including sizes and types), memory blocks, physical link paths, fabric topologies, among other attributes that would be implemented in order to realize the system modeled in the HDL object. Design tools can include tools for determining the topology and fabric configurations of system on chip (SoC) and other hardware device. In some instances, the HDL object can be used as the basis for developing models and design files that can be used by manufacturing equipment to manufacture the described hardware. Indeed, an HDL object itself can be provided as an input to manufacturing system software to cause the described hardware.

In any representation of the design, the data may be stored in any form of a machine readable medium. A memory or a magnetic or optical storage such as a disc may be the machine-readable medium to store information transmitted via optical or electrical wave modulated or otherwise generated to transmit such information. When an electrical carrier wave indicating or carrying the code or design is transmitted, to the extent that copying, buffering, or re-transmission of the electrical signal is performed, a new copy is made. Thus, a communication provider or a network provider may store on a tangible, machine-readable medium, at least temporarily, an article, such as information encoded into a carrier wave, embodying techniques of embodiments of the present disclosure.

A module as used herein refers to any combination of hardware, software, and/or firmware. As an example, a module includes hardware, such as a micro-controller, associated with a non-transitory medium to store code adapted to be executed by the micro-controller. Therefore, reference to a module, in one embodiment, refers to the hardware, which is specifically configured to recognize and/or execute the code to be held on a non-transitory medium. Furthermore, in another embodiment, use of a module refers to the non-transitory medium including the code, which is specifically adapted to be executed by the microcontroller to perform predetermined operations. And as can be inferred, in yet another embodiment, the term module (in this example) may refer to the combination of the microcontroller and the non-transitory medium. Often module boundaries that are illustrated as separate commonly vary and potentially overlap. For example, a first and a second module may share hardware, software, firmware, or a combination thereof, while potentially retaining some independent hardware, software, or firmware. In one embodiment, use of the term logic includes hardware, such as transistors, registers, or other hardware, such as programmable logic devices.

Use of the phrase ‘to’ or ‘configured to,’ in one embodiment, refers to arranging, putting together, manufacturing, offering to sell, importing and/or designing an apparatus, hardware, logic, or element to perform a designated or determined task. In this example, an apparatus or element thereof that is not operating is still ‘configured to’ perform a designated task if it is designed, coupled, and/or interconnected to perform said designated task. As a purely illustrative example, a logic gate may provide a 0 or a 1 during operation. But a logic gate ‘configured to’ provide an enable signal to a clock does not include every potential logic gate that may provide a 1 or 0. Instead, the logic gate is one coupled in some manner that during operation the 1 or 0 output is to enable the clock. Note once again that use of the term ‘configured to’ does not require operation, but instead focus on the latent state of an apparatus, hardware, and/or element, where in the latent state the apparatus, hardware, and/or element is designed to perform a particular task when the apparatus, hardware, and/or element is operating.

Furthermore, use of the phrases ‘capable of/to,’ and or ‘operable to,’ in one embodiment, refers to some apparatus, logic, hardware, and/or element designed in such a way to enable use of the apparatus, logic, hardware, and/or element in a specified manner. Note as above that use of to, capable to, or operable to, in one embodiment, refers to the latent state of an apparatus, logic, hardware, and/or element, where the apparatus, logic, hardware, and/or element is not operating but is designed in such a manner to enable use of an apparatus in a specified manner.

A value, as used herein, includes any known representation of a number, a state, a logical state, or a binary logical state. Often, the use of logic levels, logic values, or logical values is also referred to as 1's and 0's, which simply represents binary logic states. For example, a 1 refers to a high logic level and 0 refers to a low logic level. In one embodiment, a storage cell, such as a transistor or flash cell, may be capable of holding a single logical value or multiple logical values. However, other representations of values in computer systems have been used. For example, the decimal number ten may also be represented as a binary value of 418A0 and a hexadecimal letter A. Therefore, a value includes any representation of information capable of being held in a computer system.

Moreover, states may be represented by values or portions of values. As an example, a first value, such as a logical one, may represent a default or initial state, while a second value, such as a logical zero, may represent a non-default state. In addition, the terms reset and set, in one embodiment, refer to a default and an updated value or state, respectively. For example, a default value potentially includes a high logical value, e.g., reset, while an updated value potentially includes a low logical value, e.g., set. Note that any combination of values may be utilized to represent any number of states.

The embodiments of methods, hardware, software, firmware or code set forth above may be implemented via instructions or code stored on a machine-accessible, machine readable, computer accessible, or computer readable medium which are executable by a processing element. A non-transitory machine-accessible/readable medium includes any mechanism that provides (e.g., stores and/or transmits) information in a form readable by a machine, such as a computer or electronic system. For example, a non-transitory machine-accessible medium includes random-access memory (RAM), such as static RAM (SRAM) or dynamic RAM (DRAM); ROM; magnetic or optical storage medium; flash memory devices; electrical storage devices; optical storage devices; acoustical storage devices; other form of storage devices for holding information received from transitory (propagated) signals (e.g., carrier waves, infrared signals, digital signals); etc., which are to be distinguished from the non-transitory mediums that may receive information there from.

Instructions used to program logic to perform embodiments of the disclosure may be stored within a memory in the system, such as DRAM, cache, flash memory, or other storage. Furthermore, the instructions can be distributed via a network or by way of other computer readable media. Thus a machine-readable medium may include any mechanism for storing or transmitting information in a form readable by a machine (e.g., a computer), but is not limited to, floppy diskettes, optical disks, Compact Disc, Read-Only Memory (CD-ROMs), and magneto-optical disks, Read-Only Memory (ROMs), Random Access Memory (RAM), Erasable Programmable Read-Only Memory (EPROM), Electrically Erasable Programmable Read-Only Memory (EEPROM), magnetic or optical cards, flash memory, or a tangible, machine-readable storage used in the transmission of information over the Internet via electrical, optical, acoustical or other forms of propagated signals (e.g., carrier waves, infrared signals, digital signals, etc.). Accordingly, the computer-readable medium includes any type of tangible machine-readable medium suitable for storing or transmitting electronic instructions or information in a form readable by a machine (e.g., a computer).

The following examples pertain to embodiments in accordance with this Specification. Example 1 is an apparatus including: one or more ports to couple to one or more other devices over two or more links, where the one or more ports include protocol circuitry to: implement a plurality of different link protocols; implement an aggregated link of the two or more links to couple to a given one of the one or more other devices; and manage a protocol resource based on the aggregated link.

Example 2 includes the subject matter of example 1, where the plurality of different link protocols include an I/O protocol and at least one cache coherent protocol.

Example 3 includes the subject matter of example 2, where the at least one cache coherent protocol includes a first protocol to enforce coherency of a cache of memory of the given device, and a second protocol to enforce coherency of a cache maintained by the given device.

Example 4 includes the subject matter of example 3, where the I/O protocol includes CXL.io, the first protocol includes CXL.cache, and the second protocol includes CXL.mem.

Example 5 includes the subject matter of any one of examples 3-4, further including the protocol resource, where the protocol resource includes the cache of the memory, and management of the protocol resource includes responding to snoops of the cache.

Example 6 includes the subject matter of example 5, where the cache includes a common cache shared across the two or more links.

Example 7 includes the subject matter of example 5, where the cache includes two or more caches mapped respectively to the two or more links.

Example 8 includes the subject matter of example 3, where the protocol resource comprises a tracker to manage transmission of snoops of the cache on the plurality of interconnects.

Example 9 includes the subject matter of example 2, further including the protocol resource, where the protocol resource includes an address translation cache to be shared across the plurality of interconnects.

Example 10 includes the subject matter of example 9, where the address translation cache is to be for use with the I/O protocol.

Example 11 includes the subject matter of example 9, where the address translation cache includes two or more address translation caches respectively mapped to the two or more links.

Example 12 includes the subject matter of any one of examples 9-11, where management of the protocol resource includes managing address invalidations for the address translation cache.

Example 13 includes the subject matter of any one of examples 1-12, where the one or more ports include a full capability port to couple to a first one of the two or more links and a streamlined port to couple to a second one of the two or more links.

Example 14 is a method including: aggregating a plurality of links on a first device to function logically as a single link, where the plurality of links couple the first device to a second device; managing a resource of the first device based on the aggregation of the plurality of links, where the resource includes one of an address translation cache or a memory cache.

Example 15 includes the subject matter of example 14, where the first device implements the plurality of links based on one of a plurality of protocols supported by the first device.

Example 16 includes the subject matter of example 15, where the plurality of different link protocols include an I/O protocol and at least one cache coherent protocol.

Example 17 includes the subject matter of example 16, where the at least one cache coherent protocol includes a first protocol to enforce coherency of a cache of memory of the given device, and a second protocol to enforce coherency of a cache maintained by the given device.

Example 18 includes the subject matter of example 17, where the I/O protocol includes CXL.io, the first protocol includes CXL.cache, and the second protocol includes CXL.mem.

Example 19 includes the subject matter of any one of examples 17-18, where the resource includes the cache of the memory, and managing the resource includes responding to snoops of the cache.

Example 20 includes the subject matter of example 19, where the cache includes a common cache shared across the plurality of links.

Example 21 includes the subject matter of example 19, where the cache includes two or more caches mapped respectively to the plurality of links.

Example 22 includes the subject matter of any one of examples 17-18, where the resource includes the cache maintained by the given device, and managing the resource includes managing transmission of snoops of the cache on the two or more links.

Example 23 includes the subject matter of example 16, where the resource includes an address translation cache for use with the I/O protocol.

Example 24 includes the subject matter of example 23, where the address translation cache is to be shared across the plurality of links.

Example 25 includes the subject matter of example 23, where the address translation cache includes two or more address translation caches respectively mapped to the plurality links.

Example 26 includes the subject matter of any one of examples 23-25, where managing the resource includes managing address invalidations for the address translation cache.

Example 27 includes the subject matter of any one of examples 14-26, where the one or more ports include a full capability port to couple to a first one of the two or more links and a streamlined port to couple to a second one of the two or more links.

Example 28 is a system including means to perform the method of any one of examples 14-26.

Example 29 includes the subject matter of example 28, where the means include a non-transitory computer readable storage medium with instructions stored thereon, the instructions executable by a machine to cause the machine to perform at least a portion of the method of any one of examples 14-26.

Example 30 is a system including: a first device; and a second device coupled to the first device by a plurality of interconnects, where the second device includes protocol circuitry to: implement a plurality of different link protocols; implement an aggregated link on the plurality of interconnects to exchange with the first device; and manage a protocol resource based on the aggregated link.

Example 31 includes the subject matter of example 30, where the plurality of different link protocols include an I/O protocol and at least one cache coherent protocol.

Example 32 includes the subject matter of example 31, where the at least one cache coherent protocol includes a first protocol to enforce coherency of a cache of memory of the first device, and a second protocol to enforce coherency of a cache maintained by the first device.

Example 33 includes the subject matter of example 32, where the I/O protocol includes CXL.io, the first protocol includes CXL.cache, and the second protocol includes CXL.mem.

Example 34 includes the subject matter of any one of examples 32-33, further including the protocol resource, where the protocol resource includes the cache of the memory, and management of the protocol resource includes responding to snoops of the cache.

Example 35 includes the subject matter of example 34, where the cache includes a common cache shared across the plurality of interconnects.

Example 36 includes the subject matter of example 34, where the cache includes a plurality of caches mapped respectively to the plurality of interconnects.

Example 37 includes the subject matter of example 32, where the protocol resource includes the cache maintained by the first device, and management of the cache includes managing transmission of snoops of the cache on the plurality of interconnects.

Example 38 includes the subject matter of example 31, further including the protocol resource, where the protocol resource includes an address translation cache for use with the I/O protocol.

Example 39 includes the subject matter of example 38, where the address translation cache is to be shared across the plurality of interconnects.

Example 40 includes the subject matter of example 38, where the address translation cache includes a plurality of address translation caches respectively mapped to the plurality of interconnects.

Example 41 includes the subject matter of any one of examples 38-40, where management of the protocol resource includes managing address invalidations for the address translation cache.

Example 42 includes the subject matter of any one of examples 30-41, where the first device includes a host device, and the second device includes an I/O device.

Example 43 includes the subject matter of example 42, where the I/O device includes a memory device.

Example 44 includes the subject matter of example 42, where the I/O device includes a hardware accelerator device.

Example 45 includes the subject matter of example 42, where the I/O device includes a networking device.

Example 46 includes the subject matter of any one of examples 30-45, where each of the plurality of interconnects includes a corresponding plurality of physical lanes.

Example 47 includes the subject matter of any one of examples 30-46, where the one or more ports include a full capability port to couple to a first one of the two or more links and a streamlined port to couple to a second one of the two or more links.

Reference throughout this specification to “one embodiment” or “an embodiment” means that a particular feature, structure, or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplary language does not necessarily refer to the same embodiment or the same example, but may refer to different and distinct embodiments, as well as potentially the same embodiment.

What is claimed is:

1. An apparatus comprising:
a plurality of ports to couple to one or more other devices over a plurality of interconnects, wherein the one or more ports comprise protocol circuitry to:
implement a plurality of different link protocols;
implement an aggregated link on the plurality of interconnects to couple to a given one of the one or more other devices; and
manage a protocol resource based on the aggregated link.

2. The apparatus of claim 1, wherein the plurality of different link protocols comprise an I/O protocol and at least one cache coherent protocol.

3. The apparatus of claim 2, wherein the at least one cache coherent protocol comprises a first protocol to enforce coherency of a cache of memory of the given device, and a second protocol to enforce coherency of a cache maintained by the given device.

4. The apparatus of claim 3, wherein the I/O protocol comprises CXL.io, the first protocol comprises CXL.cache, and the second protocol comprises CXL.mem.

5. The apparatus of claim 3, further comprising the protocol resource, wherein the protocol resource comprises the cache of the memory of the given device, and management of the protocol resource comprises responding to snoops of the cache of the memory of the given device.

6. The apparatus of claim 5, wherein the cache comprises a common cache shared across the plurality of interconnects.

7. The apparatus of claim 5, wherein the cache comprises two or more caches mapped respectively to the plurality of interconnects.

8. The apparatus of claim 3, wherein the protocol resource comprises a tracker to manage transmission of snoops of the cache on the plurality of interconnects.

9. The apparatus of claim 2, further comprising the protocol resource, wherein the protocol resource comprises an address translation cache to be shared across the plurality of interconnects.

10. The apparatus of claim 9, wherein the address translation cache is for use with the I/O protocol.

11. The apparatus of claim 9, wherein the address translation cache comprises two or more address translation caches respectively mapped to the plurality of interconnects.

12. The apparatus of claim 9, wherein management of the protocol resource comprises managing address invalidations for the address translation cache.

13. The apparatus of claim 1, wherein the one or more ports comprise a full capability port to couple to a first one of the plurality of interconnects and a streamlined port to couple to a second one of the plurality of interconnects.

14. A method comprising:
aggregating a plurality of links on a first device as a bundled link to function logically as a single link, wherein the plurality of links couple the first device to a second device, and the plurality of links are to be respectively implemented based on a Compute Express Link (CXL)-based protocol;
communicating data between the first device and the second device using the bundled link; and
managing a resource of the first device based on the aggregation of the plurality of links, wherein the resource comprises one of an address translation cache or a memory cache.

15. The method of claim 14, wherein the resource comprises the memory cache, and the memory cache comprises a cache maintained for the plurality of links at the first device to cache memory of the second device.

16. The method of claim 14, wherein the resource comprises the address translation cache, and address translation cache is to be shared between the plurality of links.

17. A system comprising:
a first device; and
a second device coupled to the first device by a plurality of interconnects, wherein the second device couples to the plurality of interconnect by a plurality of ports, and comprises protocol circuitry to:
implement a plurality of different link protocols;
implement a bundled link to aggregate the plurality of interconnects to act as a single logical interconnect;
communicate data between the first device and the second device through the bundled link; and
manage a protocol resource based on the aggregated link.

18. The system of claim 17, wherein the plurality of different link protocols comprise CXL.io, CXL.mem, and CXL.cache.

19. The system of claim 17, wherein the second device comprises one of a memory device, a hardware accelerator device, a graphics processor, or a networking device.

20. The system of claim 17, wherein the plurality of ports comprise at least one full capability port to couple to a first one of the plurality of interconnects and at least one streamlined port to couple to a second one of the plurality of interconnects.
